(19) United States
(12) Patent Application Publication
(10) Pub. No.: US 2026/0219826 A1
(43) Pub. Date: Jul. 30, 2026

(54) SYSTEM AND METHOD OF EXECUTING A DIGITAL DISPLAY DEVICES AUDIO AND VIDEO CONTEXTUAL ENGINE SYSTEM TO OPERATE A UNIFIED VIRTUAL ADAPTIVE USER INTERFACE ACROSS PLURAL DIGITAL DISPLAY DEVICES

(71) Applicant: Dell Products LP, Round Rock, TX (US)

(72) Inventors: Rachid M. Alameh, Crystal Lake, IL (US); Gerald Rene Pelissier, Santa Clara, CA (US); Jarrett Simerson, Northbrook, IL (US); Edward J. Yurchik, JR., Algonquin, IL (US)

(73) Assignee: Dell Products LP, Round Rock, TX (US)

(21) Appl. No.: 19/038,989

(22) Filed: Jan. 28, 2025

(51) Int. Cl. G06F 3/14; G06F 3/16; H04R 1/02; H04R 1/40; H04R 3/00

(52) U.S. Cl. CPC G06F 3/1423; G06F 3/162; H04R 1/028; H04R 1/406; H04R 3/005; H04R 2201/401; H04R 2430/01; H04R 2499/15

(57) ABSTRACT

An information handling system comprising a network interface device to detect operatively coupling of plural standalone digital display devices to form a digital workspace and to automatically receive location data of plural standalone digital display devices relative to each other determined from detected exchange of sound, infrared, or other waves between them and a hardware processor executing machine readable code instructions of a digital display devices audio and visual contextual engine system to unify operation of digital workspace I/O devices including a first microphone and a first speaker at a first standalone digital display device and a second microphone and a second speaker at a second standalone digital display device to operate as a unified virtual adaptive user interface. The hardware processor to utilize the digital workspace I/O devices to detect a user location and to automatically adjust operation of the plural standalone digital display devices in the digital workspace.

### FIELD OF THE DISCLOSURE

The present disclosure relates to operation of an information handling system with a plurality of standalone digital display devices in a digital workspace. The present disclosure more specifically relates to executing machine readable code instructions of a digital display devices audio and visual contextual engine system to operate a unified virtual adaptive user interface for automatic adjustment and tuning across the plural standalone digital display devices and the information handling system within the digital workspace.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may operate audio and visual input and output devices including one or more digital display devices, cameras, speakers, or microphones for a user to conduct such digital communication capabilities or operation of the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system executing machine readable code instructions of a digital display devices audio and visual contextual engine system to operate a unified virtual adaptive user interface for automatic adjustment and tuning across plural standalone digital display devices and the information handling system according to an embodiment of the present disclosure;

FIG. 2 is a block diagram illustrating a digital workspace including an information handling system executing machine readable code instructions a digital display devices audio and visual contextual engine system to operate a unified virtual adaptive user interface across plural standalone digital display devices and the information handling system in the digital workspace according to an embodiment of the present disclosure;

FIG. 3 is a graphical diagram illustrating a digital workspace including a unified virtual adaptive user interface for automatic adjustment and tuning across plural standalone digital display devices and an information handling system in the digital workspace according to an embodiment of the present disclosure;

FIG. 4 is a graphical diagram illustrating a digital workspace including a unified virtual adaptive user interface for automatic adjustment and tuning across plural standalone digital display devices in the digital workspace according to another embodiment of the present disclosure; and

FIG. 5 is a flow diagram illustrating a method of executing machine readable code instructions of a digital display devices audio and visual contextual engine system to operate a unified virtual adaptive user interface for automatic adjustment and tuning across plural standalone digital display devices and an information handling system in a digital workspace according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Standalone digital display devices, for example, are operatively coupled by users to information handling systems to form digital workspaces. It is common now for users to attach plural standalone digital display devices to an information handling system, such as a laptop type information handling system, that has its own integrated digital display device. Further, these plural standalone digital display devices may include input/output (I/O) devices, sensors, or features such as cameras, speakers or microphones in addition to similar sensors or features on the information handling system within the digital workspace. This may cause redundancy of systems, conflict in the operation of the display panels, or conflicts in the operation of the various I/O devices or sensors, such as microphones, speakers, or cameras, when operating in the digital workspace. Further, a user in the digital workspace may utilize any of plural standalone digital display devices or the information handling system as a primary working system at any given time while others may be secondary. Upon attaching plural standalone digital display devices to the information handling system or a docking station in a digital workspace may require manual setup of each of the plural standalone digital display devices and the information handling system to accommodate viewing or audio for the location of the user. A system is needed to provide best audibility and viewability for a user automatically upon operatively coupling plural standalone digital display devices to an information handling system in a digital workspace. Currently, standalone digital display devices are not able to automatically determine such audibility and viewability to satisfactorily set up the I/O devices and sensors such as the display panels, microphones, speakers, cameras or others of each standalone digital display device and the information handling system within a digital workspace.

In embodiments of the present disclosure, the information handling system in the digital workspace executes machine readable code instructions to detect when plural standalone digital display devices are operatively coupled to the information handling system directly or via a docking station. The information handling system in the digital workspace executes the machine readable code instructions of a digital display devices audio and visual contextual engine system to unify operation of digital workspace I/O devices including plural display panels, microphones, speakers, and other sensors of the standalone digital display devices and the information handling system, when active, to form a unified virtual adaptive user interface across the plural standalone digital display devices in the digital workspace in embodiments of the present disclosure. The information handling system executes the machine readable code instructions of the digital display devices audio and visual contextual engine system to automatically trigger sets of code instructions of digital devices location detection systems to be executed at each of the detected plural standalone digital devices operatively coupled in the digital workspace.

A hardware controller or other hardware processing resource on each of the plural standalone digital devices executes the machine readable code instructions of the digital devices location detection system to utilize sound with microphone beamforming, infrared proximity sensors, capacitive proximity sensors, ultra wide band RF technologies proximity sensor, or other proximity sensing technologies utilizing energy or sound waves to determine a location of other standalone digital display devices relative to each standalone digital display device and the information handling system, if active as an interface, within the digital workspace. For example, a first standalone digital display device may execute a digital devices location detection system utilize a speaker to play a tone or sound, such as a beep or an inaudible tone, from at least one speaker on the first standalone digital display device in an embodiment and send indication of the tone to the information handling system. The information handling system executes the digital display devices audio and visual contextual engine system to coordinate with a second standalone digital display device to execute its digital devices location detection system to activate a microphone or plural microphones to receive the tone played by the first standalone digital display device. In this example, the standalone monitors audio is sequentially triggered with one generating a sound and the other only detecting the sound and vice versa. The digital devices location detection system then executes at the second standalone digital display device to beamform the direction of the tone played to identify the location of the first standalone digital display device relative to the second standalone digital display device in an embodiment. The second standalone digital display device may then report the location data of the first standalone digital display device to the digital display devices audio and visual contextual engine system at the information handling system.

In some further embodiments, the second standalone digital display device may execute machine readable code instructions of digital devices location detection system to play a tone at a speaker of the second standalone digital display device in the digital workspace and report playing of that tone to the digital display devices audio and visual contextual engine system at the information handling system. This may trigger the first standalone digital display device to execute its digital devices location detection system thereon to detect the tone via one or more microphones on the first standalone digital display device. The digital devices location detection system then executes at the first standalone digital display device to beamform the direction of the tone played to identify the location of the second standalone digital display device relative to the first standalone digital display device in an embodiment. The first standalone digital display device may then report the location data of the second standalone digital display device to the digital display devices audio and visual contextual engine system at the information handling system. This process may be repeated among any plurality of standalone digital display devices upon detection operatively coupling to the information handling system within the digital workspace in embodiments herein.

In another embodiment, the plural standalone digital display devices may include infrared proximity sensors, ultrawide band sensors, directional RF sensors, or imagers which may be side-mounted to each of the plural standalone digital display devices. Focusing on the infrared sensors, since the plural digital display devices are typically placed adjacent to one another when operatively coupled within a digital workspace, these infrared proximity sensors may be used on each standalone digital display device to detect direction and location of other standalone digital display devices within the digital workspace upon operatively coupling to the information handling system in embodiments herein. The digital devices location detection system, for example, executes at a first standalone digital display device to transmit infrared beams from one or more infrared proximity detectors and reports the same to the information handling system. The digital devices location detection system executing at a second standalone digital display device is notified of the infrared transmission and uses its side mounted infrared proximity sensors to detect from which direction and distance the infrared transmission comes from to identify the location of the first standalone digital display device relative to the second standalone digital display device in an embodiment. The second standalone digital display may have an orientation sensor for its orientation such that the received side of the infrared transmission may identify a direction of the source infrared transmission relative to the second standalone digital display device. The second standalone digital display device may then report the location data of the first standalone digital display device to the digital display devices audio and visual contextual engine system at the information handling system.

Although infrared proximity sensor technologies is used as an example embodiment, it is contemplated that in one embodiment, an infrared transmitter is at one standalone digital display device and an infrared receiver is at the other standalone digital display device to operate with split unidirectional infrared exchange between the standalone digital display devices. In other embodiments, the infrared sensors are used as true proximity sensors, with transmission and reception mounted to one side of each to the standalone digital display devices and reflects off the body of the adjacent standalone digital display device to determine direction. Further, it is contemplated in some embodiments that infrared wave exchange in the above embodiments may be replaced with ultrawide band radiofrequency sensors that can measure range and angle of the nearby displays in a similar fashion to the IR sensors with either split transmission and reception or combined proximity sensing by reflection. It is contemplated in yet other embodiments that capacitive sensors can also be used on one side of the standalone digital display devices to sense the presence of the adjacent standalone digital display device having a conductive body sitting within 3 ft from first standalone digital display device. In this case, the standalone digital display device that senses the adjacent standalone digital display device conductive body determines a direction and location based on the side that the capacitive sensor is mounted on each standalone digital display device in embodiments herein.

Similarly, in embodiments, the second standalone information handling system may transmit an infrared signal which may be detected by side mounted infrared sensors at the first standalone digital display device. The first standalone digital display device may then execute machine readable code instructions of the digital devices location detection system, for example, to identify location direction and distance of the second standalone digital display device from the receipt of the infrared transmission. The first standalone digital display device may then report the location data of the second standalone digital display device to the digital display devices audio and visual contextual engine system at the information handling system.

Once the location data for each of the plural standalone digital display devices within the digital workspace is received at the digital display devices audio and visual contextual engine system at the information handling system, the hardware processor unifies operation of digital workspace I/O devices including display panels, microphones, speakers, cameras, infrared proximity sensors, and other I/O sensors at the plural digital display devices to operate as a unified virtual adaptive user interface for the digital workspace. For example, the hardware processor executing the digital display devices audio and visual contextual engine system utilizes at least one camera system, one or more microphones, an infrared, ultrasound, radiofrequency, or other range sensor or other sensor of the unified digital workspace I/O devices to identify and locate a user's direction and distance from the plural standalone digital display devices within the digital workspace in embodiments herein. Upon determination of a location and relative angle of a user within the digital workspace, the digital display devices audio and visual contextual engine system executes to automatically adjust and tune operation of each of the standalone digital display devices and their unified digital workspace I/O devices as part of the unified virtual adaptive user interface based on the location of the user and relative to the location of the plural digital display devices in the mapping of the digital workspace.

In some embodiments, the hardware processor executing machine readable code instructions of a digital display devices audio and visual contextual engine system may detect when a laptop lid is open or a tablet display device is active to include an integrated display device, and any integrated I/O sensors such as microphones, speakers, cameras or the like of the information handling system with the unified operation of the unified digital workspace I/O devices and sensors as part of the unified virtual adaptive user interface when the laptop lid is open. The user's location or changes to the plural standalone digital display devices operatively coupled in the digital workspace as mapped may be monitored and any changes may trigger automatic adjustments to the mapping of the digital workspace or to the enabling, disabling, tuning, or adjustment of the unified digital workspace I/O devices and sensors for a user's location as part of the unified virtual adaptive user interface in embodiments of the present disclosure. This entails combining or switching the various I/O devices used within the superset of unified digital workspace I/O devices based on user position and operating the unified digital workspace I/O devices such that redundant components may be removed, such as adjacent microphones on side-by-side standalone digital display devices.

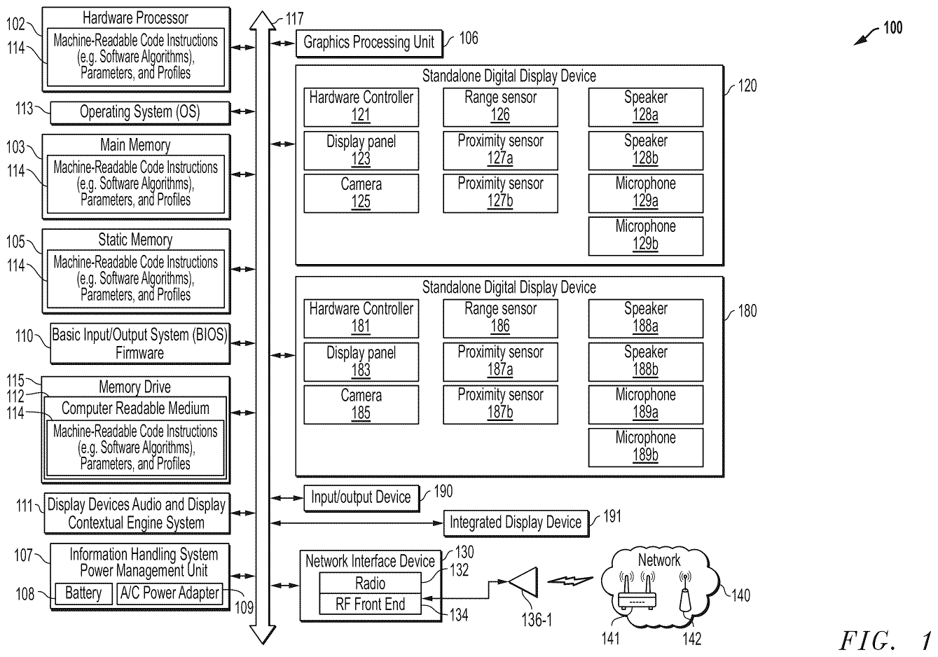

Turning now to the figures, FIG. 1 illustrates an information handling system 100 similar to the information handling systems according to several aspects of the present disclosure. As described herein, plural digital display devices 120 and 180, for example, are operatively coupled to an information handling system 100 by a user to form a digital workspace. The digital workspace may include, in some embodiments, the information handling system 100 which includes an integrated display device 191, such as for a laptop-type or table-type information handling system. In some embodiments, the user may utilize the integrated display device 191 and input/output devices 190 of the information handling system 100 as part of the digital workspace.

The plural standalone digital display devices 120 and 180 as well as the information handling system 100 may include their own set of I/O devices or sensors. For example, standalone digital display device 120 may include a hardware controller 121, a display panel 123, a camera 125, one or more speakers or microphones in addition to similar sensors or features on the information handling system within the digital workspace. This may cause redundancy of systems, conflict in the operation of the display panels as well as the various input/output (I/O) sensors, such as microphones, speakers, or cameras, when operating in the digital workspace. Further, a user in the digital workspace may utilize any of the plural standalone digital display devices 120 or 180 or the information handling system 100 and its integrated display device 191 as a primary working system at any given time while others may be secondary. The user may position herself within the digital workspace accordingly. Upon attaching plural standalone digital display devices 120 and 180 to the information handling system 100 or a docking station (not shown) will typically require manual setup of each of the plural standalone digital display devices 120 and 180 and the information handling system 100, including I/O devices such as the integrated display device 191 when active, in the digital workspace to accommodate viewing or audio for the location of the user.

In embodiments of the present disclosure, the information handling system 100 in the digital workspace operates machine readable code instructions 114 to detect when plural standalone digital display devices 120 and 180 are operatively coupled to the information handling system 100 directly or via a docking station. For example, ports on the information handling system 100 or docking station may detect that plural standalone digital display devices 120 and 180 have been plugged in and are active with the information handling system 100 in the digital workspace. In another example embodiment, the information handling system 100 may detect the wireless interface adapter 130 has wirelessly paired with the plural standalone digital display devices 120 and 180 such that they are active with the information handing system 100 in the digital workspace. The information handling system 100 executes machine readable code instructions 114 of a digital display devices audio and visual contextual engine system 111 to assess the IO devices of the plural standalone digital display device 120 and 180 as well as the information handling system 100 in the digital workspace and unify operation of digital workspace I/O devices including plural display panels, microphones, speakers, and other sensors of the standalone digital display devices 120 and 180 and the information handling system 100 to form a unified virtual adaptive user interface across the plural standalone digital display devices 120 and 180 and information handling system 100, including the integrated display device 191 if open or active, in the digital workspace. The information handling system 100 executes the machine readable code instructions 114 of a digital display devices audio and visual contextual engine system 111 to automatically trigger code instructions of a digital devices location detection systems to be executed by hardware controllers 121 and 181 at each of the detected the plural standalone digital display devices 120 and 180, respectively, upon detection that they are operatively coupled in the digital workspace. Such digital devices location detection systems may not need to be activated when only one standalone digital display device (e.g., 120 or 180) is operatively coupled. It is contemplated, however, that any number of standalone digital display devices 120, 180, from one standalone digital display device 120 and an integrated display device 191, or a greater plurality of standalone digital display devices may be detected as operatively coupled, by wire or wirelessly, to the information handling system 100 to automatically trigger execution of digital devices location detection systems at those standalone digital display devices 120, 180 in other embodiments herein.

A hardware controller 121 or 181 or other hardware processing resource on each of the plural standalone digital devices 120 or 180 executes the machine readable code instructions of the digital devices location detection system thereon to utilize exchange of sound, infrared, radiofrequency or other waves to automatically determine a location of each standalone digital display device 120 relative to other standalone digital display devices 180 and the information handling system 100 within the digital workspace. For example, a first standalone digital display device 120 may execute a digital devices location detection system utilize a first speaker 128a to play a tone or sound, such as a beep or an inaudible tone, from at least the first speaker 128a on the first standalone digital display device 120 in an embodiment. The hardware controller 121 will then send indication of the tone being played to the information handling system 100 on a control channel of the operative coupling. The information handling system 100 executing the digital display devices audio and visual contextual engine system 111 then coordinates with the second standalone digital display device 180 to execute its digital devices location detection system to activate a first microphone 189a or plural microphones 189a and 189b to receive the tone played by the first standalone digital display device 120. The digital devices location detection system then executes at the second standalone digital display device 180 to beamform the direction of the tone played from the single microphone 189a, if it is a beamforming microphone, or plural microphones 189a and 189b at known locations on the second standalone digital display device 180 to identify the location of the first standalone digital display device 120 relative to the second standalone digital display device 180 in an embodiment. The second standalone digital display 180 may have an orientation sensor for its orientation such that the beamforming data detected by the single beamforming microphone 189a or plural microphones 189a and 189b at know locations may identify a direction of the tone relative to the second standalone digital display device 180. In an example embodiment, one of the microphones, for example 189a, may be a beamforming microphone that includes an array of microphones at a location which may be used to detect a doppler shift of sound to determine source location for beamforming identification of the location of the source. In another example embodiment, two microphones 189a and 189b, spaced on the chassis of the second standalone digital display device 180 may be used to detect a doppler shift of sound received at both microphones 189a and 189b to determine a beamforming direction of the source location of the sound. The second standalone digital display device then reports location data of the first standalone digital display device 120, determined from the beamforming determined direction and distance, to the digital display devices audio and visual contextual engine system 111 at the information handling system 100.

It is understood that additional information location data of the first standalone digital display device 120 may be determined by the hardware controller 121 of first standalone digital display device 120 causing a second tone to be played by speaker 128b. The digital display devices audio and visual contextual engine system 111 at the information handling system 100 may then receive notification of the second tone and coordinate the second standalone digital display device to active a beamforming microphone 189a or plural microphones 189a and 189b to detect the second tone played. With the second tone from a second speaker 128a on the first information handling system 120, additional location information of the first standalone digital display device 120 may be determined with beamforming by the display device location detection system as to direction and distance. This location information of the first standalone digital display device 120 may then be transmitted to the digital display devices audio and visual contextual engine system 111 at the information handling system 100 by the second standalone digital display device 180 in embodiments herein.

In a further embodiment, the second standalone digital display device 180 may execute machine readable code instructions of digital devices location detection system to play a tone at a speaker 188a of the second standalone digital display device 180 in the digital workspace and report playing of that tone to the digital display devices audio and visual contextual engine system 111 at the information handling system 100. This may be reported to the first standalone digital display device 120 to trigger its execution of the digital devices location detection system thereon to detect the tone via one or more microphones 129a or 129b located at one or more known locations on the first standalone digital display device 120 in embodiments herein. The digital devices location detection system then executes at the first standalone digital display device 120 to beamform the direction and distance of the tone played via detection of doppler shift techniques to identify the location of the second standalone digital display device 180 relative to the first standalone digital display device 120 in an embodiment. The first standalone digital display 120 may also have an orientation sensor for its orientation such that the beamforming data may identify a direction and distance of the source tone location relative to the first standalone digital display device 120. The first standalone digital display device 120 may then report the location data of the second standalone digital display device 180 to the digital display devices audio and visual contextual engine system 111 at the information handling system 100. As before, for more accurate location and distance data of the second standalone digital display device 180 in the digital workspace, the process may be repeated with a tone played at a second speaker 188b at the second standalone digital display device 180 and detected by one or more speakers 129a or 129b at the first standalone digital display device 120. In further embodiments herein, this process may be repeated among any plurality of standalone digital display devices operatively coupled to the information handling system 100 upon their detection within the digital workspace in embodiments herein. This process may include determination of location between any one standalone digital display device 120 and 180 and the information handling system 100 as well as any additional standalone digital display devices within the digital workspace. With location information received at the digital display devices audio and visual contextual engine system 111 at the information handling system 100, the digital display devices audio and visual contextual engine system 111 may then configure a mapping of the digital workspace from relative locations between the plural standalone digital display devices 120, 180 and the information handling system 100 in embodiments herein. With additional orientation sensor data of each of the plural standalone digital display devices 120, 180 and the plural location data information from two speakers 129a, 129b or 189a, 189b at known locations on the chassis of the plural standalone digital display devices 120, 180, the orientation or faced positioning of the display panels 123 and 183 of each of the plural standalone digital display devices 120, 180 may be determined within the digital workspace by the digital display devices audio and visual contextual engine system 111.

In another embodiment, the plural standalone digital display devices 120 and 180 may include infrared proximity sensors 127a, 127b and 187a, 187b which may be side-mounted to each of the plural standalone digital display devices 120 and 180 respectively. Other technologies can be used including capacitive proximity sensors, ultrawide band RF proximity sensors, ultrasound proximity sensors, cameras or others. Since the plural digital display devices 120 and 180 are typically placed adjacent to one another when operatively coupled within a digital workspace, these infrared proximity sensors 127a, 127b and 187a, 187b may be used on each standalone digital display device 120 and 180 to detect direction and location of other standalone digital display devices within the digital workspace upon operatively coupling to the information handling system 100 in embodiments herein. The digital devices location detection system, for example, executes via a hardware controller 121 at a first standalone digital display device 120 to transmit infrared beams from one or more infrared proximity detectors 127a, 127b and reports the same to the information handling system 100. The digital devices location detection system executing at a second standalone digital display device 180 is notified of the infrared transmission and uses its side mounted infrared proximity sensors 187a, 187b to detect from which direction and distance the infrared transmission comes from to identify the location of the first standalone digital display device 120 relative to the second standalone digital display device 180 in an embodiment. The second standalone digital display 180 may have an orientation sensor for its orientation such that the received side of the infrared transmission may identify a direction of the source infrared transmission relative to the second standalone digital display device 180. The second standalone digital display device 180 may then report the location data of the first standalone digital display device 120 to the digital display devices audio and visual contextual engine system 111 at the information handling system 100.

Similarly, in embodiments, the second standalone information handling system 180 may transmit an infrared signal with its side mounted infrared sensors 187a, 187b which may be detected by side mounted infrared sensors 127a, 127b at the first standalone digital display device 120. The first standalone digital display device 120 may then execute machine readable code instructions of the digital devices location detection system, for example, to identify location direction and distance of the second standalone digital display device 180 from the receipt of the infrared transmission at one of the side mounted infrared sensors 127a, 127b on the first standalone digital display device 120. The first standalone digital display device 120 may then report the location data of the second standalone digital display device 180 to the digital display devices audio and visual contextual engine system 111 at the information handling system 100.

Once the location data, from either sound or infrared wave exchange, for each of the plural standalone digital display devices 120 and 180 within the digital workspace is received at the digital display devices audio and visual contextual engine system 111 at the information handling system 100, the hardware processor 102, an embedded controller, or other hardware processing resource, unifies operation of digital workspace I/O devices including display panels 123 and 183, microphones 129a, 129b, 189a and 189b, speakers 128a, 128b, 188a and 188b, cameras 125 and 185, infrared proximity sensors 127a, 127b, 187a and 187b, a range sensor 126 or 186 and other I/O sensor devices at the plural digital display devices 120 and 180 to operate as a unified virtual adaptive user interface for the digital workspace. In one example embodiment, the hardware processor 102 executing the digital display devices audio and visual contextual engine system 111 utilizes at least one camera system 125 or 185, one or more microphones 129a, 129b, 189a or 189b, a range sensor 126 or 186, or other sensors, such as capacitive sensors, ultra-wideband radiofrequency range sensors, ultrasound sensors, radiofrequency sensors, of the unified digital workspace I/O devices to identify and locate a user's direction and distance from the plural standalone digital display devices 120 and 180 within the digital workspace in embodiments herein.

The determination of the user location and direction of gaze may utilize execution of face recognition algorithms with image data from a camera 125 or 185 to identify a face and orientation of a user's face in one direction or another. Further determination of the user's location may be determined from one or more microphones 129a, 129b, 189a or 189b, a range sensor 126 or 186, or even a camera 125 or 185 with range sensing capabilities to determine with beamforming the location of a user's voice or a direction of a user relative to the two or more plural standalone digital display devices 120 and 180 within the digital workspace in embodiments herein. Additionally, one or more microphones 129a, 129b, 189a or 189b, a range sensor 126 or 186, or even a camera 125 or 185 with range sensing capabilities may determine a user's distance from at least one standalone digital display device 120 or 180 within the digital workspace in embodiments herein. This user location information, including direction, distance, face orientation relative to one or more of the plural standalone digital display devices 120 or 180 may be reported back to the digital display devices audio and visual contextual engine system 111.

Upon determination of a location and orientation of a user within the digital workspace, the digital display devices audio and visual contextual engine system 111 executes to automatically adjust and tune operation of each of the standalone digital display devices 120 and 180 and their unified digital workspace I/O devices as part of the unified virtual adaptive user interface based on the location of the user relative to the location of the plural digital display devices in the digital workspace. The digital display devices audio and visual contextual engine system 111 executes to issue adjustment control commands to each standalone digital display device 120 and 180 to adjust or disable their unified digital workspace I/O devices as part of the unified virtual adaptive user interface for the user's location in the digital workspace in embodiments herein. The digital display devices audio and visual contextual engine system 111 at the information handling system issues commands to the unified digital workspace I/O devices including display panels 123 and 183, microphones 129a, 129b, 189a and 189b, speakers 128a, 128b, 188a and 188b, cameras 125 and 185, infrared proximity sensors 127a, 127b, 187a and 187b, a range sensor 126 or 186 and other I/O sensor devices to disable I/O sensor devices that may conflict or to adjust settings of those I/O sensor devices for optimizing audibility and viewability for the user at the her detected location and gaze facing orientation within the digital workspace in embodiments herein. Further, the digital display devices audio and visual contextual engine system 111 operating the unified digital workspace I/O devices including display panels 123 and 183, microphones 129a, 129b, 189a and 189b, speakers 128a, 128b, 188a and 188b, cameras 125 and 185, infrared proximity sensors 127a, 127b, 187a and 187b, a range sensor 126 or 186 and other I/O sensor devices may detect the environment, such as ambient sound or lighting of the user or whether the user is in a public location context or private location context, to further tune the unified digital workspace I/O devices of the standalone digital display devices 120 and 180 for the user's location in the digital workspace in embodiments herein.

In other embodiments, the hardware processor 102 executing machine readable code instructions of a digital display devices audio and visual contextual engine system 111 may further incorporate the information handling system 100 and I/O devices 190 such as speakers, microphones, cameras, and other sensors as well as integrated digital display device 191 within the unified virtual adaptive user interface for the user in the digital workspace. In an embodiment, the digital display devices audio and visual contextual engine system 111 may detect when a laptop lid is open or a tablet display device is active to include an integrated display device 191, and any integrated I/O devices 190 such as microphones, speakers, cameras or the like of the information handling system 100 as part of the unified operation of the unified digital workspace I/O devices within the unified virtual adaptive user interface when the laptop lid is open. Location and direction of the information handling system 100 within the digital workspace and relative to the plural standalone digital display devices 120 and 180, as well as a user, may be determined according to embodiments as described herein. In other embodiments, when the laptop lid is closed, any of the integrated display device 191, and any integrated I/O devices 190 such as microphones, speakers, cameras or the like of the information handling system 100 may be disabled by the digital display devices audio and visual contextual engine system 111 from operation as part of the unified digital workspace I/O devices within the unified virtual adaptive user interface while others may be utilized for enhance function or context sensing within the digital workspace.

In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 141, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of computer readable code instructions to perform one or more computer functions, via one or more hardware processing resources.

The information handling system 100 may include main memory 103, (volatile (e.g., random-access memory, etc.), or static memory 105, nonvolatile (read-only memory, flash memory etc.) or any combination thereof), one or more hardware processing resources, such as a hardware processor 102 that may be a central processing unit (CPU), embedded controller (EC), a graphics processing unit (GPU) 106, other hardware controllers, or any combination thereof. Additional components of the information handling system 100 may include one or more storage devices such as static memory 105 or drive unit 115. The information handling system 100 may include or interface with one or more communications ports for communicating with external devices such as one or more operatively coupled external input/output (I/O) devices 190, one or more standalone digital display devices 120 and 180, or any combination thereof. The information handling system 100 may include or interface with one or more wireless interface adapters 130 for communicating with operatively coupled external devices such as one or more external input/output (I/O) devices 190, one or more standalone digital display devices 120 and 180, or any combination thereof in other embodiments. Further, the information handling system 100 may include an integrated display device 191 as well as other integrated I/O devices 190 such as keyboard, touchpad, touchscreen, camera system, infrared or other proximity sensors, speakers, microphones, orientation and motion sensors, hall sensors, or the like. The plural standalone digital display devices 120 and 180 operatively coupled to the information handling system 100 in embodiments herein may form a digital workspace which may include the information handling system itself 100 in some embodiments. Portions of an information handling system 100 may themselves be considered information handling systems 100.

Information handling system 100 may include devices or modules that embody one or more of the hardware devices or hardware processing resources executing machine readable code instructions for one or more systems and modules. The information handling system 100 may execute machine readable code instructions (e.g., software or firmware algorithms), parameters, and profiles 114 that may operate on servers or systems, remote data centers, or on-box in individual client information handling systems according to various embodiments herein. In some embodiments, it is understood that any or all portions of machine readable code instructions (e.g., software or firmware algorithms), parameters, and profiles 114 may operate on a plurality of information handling systems 100.

The information handling system 100 may include the hardware processor 102 such as a central processing unit (CPU), graphics processing unit (GPU) 106, embedded controller (EC) or other hardware processing resources on information handling system 100. The plural standalone digital display devices 120 and 180 may include a hardware controller 121 or 181 respectively, such as scaler hardware controller, timing controller (TCON), or other hardware controller, and a display panel 123 or 183, such as an organic light emitting diode (OLED) digital display panel or an LED digital display panel. Any of the hardware processing resources may operate to execute machine readable code instructions 114 that are either firmware or software code. For example, the hardware processor 102 in some embodiments may execute machine readable code instructions 114 of the display devices audio and display contextual engine system 111 on the information handling system. The hardware controller 121 or 181 may execute machine readable digital display device firmware or software of the display devices location detection system at each of the plural standalone digital display devices 120 and 180 according to embodiments herein. Each of the plural standalone digital display devices 120 and 180 in some embodiments may include a separate hardware controller 121 and 181, such as a scaler hardware controller, to execute machine readable code instructions of display devices location detection system in embodiments herein. In such an embodiment, the plural standalone digital display devices 120 and 180 may include a hardware controller 121 or 181 that may comprise a scaler CPU, a TCON, or other on-board processor on those standalone digital display devices 120 and 180. The hardware processor 102 in the information handling system 100 may comprise a vector CPU or multi-vector CPU or may be a graphics processing unit (GPU) 106 or other hardware processing resource.

Moreover, the information handling system 100 may include memory such as main memory 103, static memory 105, and disk drive unit 115 (volatile (e.g., random-access memory, etc.), nonvolatile memory (read-only memory, flash memory etc.) or any combination thereof or other memory with computer readable medium 112 storing machine readable code instructions (e.g., software or firmware algorithms), parameters, and profiles 114 executable by the hardware processor 102, EC, GPU 106, or any other hardware processing device. The information handling system 100 may also include one or more buses 117 operable to transmit communications between the various hardware components such as any combination of various I/O devices 190, as well as between hardware processors 102, an EC, GPU 106 or other, the operating system (OS) 113, the basic input/output system (BIOS) 110, the network interface device 130, or a radio module 132, among other components described herein. Ports of the information handling system 100, such as universal serial bus (USB) ports or other ports, may be operatively coupled to one or more buses 117 via a network interface device or port controller. In an embodiment, the hardware processor 102, EC, and/or GPU 106 may execute one or more bus drivers in order to transmit this data between the information handling system 100, the integrated display device 191, and the input/output devices 190, and external devices such as external I/O devices 190 or plural standalone digital display devices 120 and 180 as described herein. As described herein, the plural standalone digital display devices 120 and 180 or the integrated display device 191 in various embodiments may function as a liquid crystal display (LCD), an organic light emitting diode (OLED) display, a light emitting diode (LED) display, a flat panel display, or a solid-state display. It is appreciated that the plural standalone digital display devices 120 and 180 may be wired or wirelessly coupled to the information handling system 100 or a docking station to allow a user to increase the display-viewable desktop area by extending the desktop displayed for the information handling system 100 in an embodiment.

A network interface device of the information handling system 100 may be wired or wireless such as shown with a network interface device that may be a wireless interface adapter 130 that can provide wireless connectivity among devices such as with Bluetooth® or to a network 140, e.g., a wide area network (WAN), a local area network (LAN), wireless local area network (WLAN), a wireless personal area network (WPAN), a wireless wide area network (WWAN), or other network. In embodiments described herein, the wireless interface adapter 130 with its radio 132, RF front end 134 and antenna 136 is used to communicate with the network 140, via, for example, a Bluetooth® or Bluetooth® Low Energy (BLE) protocols, or other WPAN or WLAN protocols. It is appreciated that a network interface device may also be provided for wired connectivity, such as having a port controller and port hardware such as USB port hardware, to operably couple by wire to external I/O devices 190 such as a docking station or plural standalone digital display devices 120 and 180 in embodiments herein.

In an embodiment, a WAN, WWAN, LAN, and WLAN may each include an AP 141 or base station 142 used to operatively couple the information handling system 100 to a network 140 via a network interface device 130. In a specific embodiment, the network 140 may include macro-cellular connections via one or more base stations 142 or a wireless AP 141 (e.g., Wi-Fi), or such as through licensed or unlicensed WWAN small cell base stations 142. Connectivity may be via wired or wireless connection. For example, wireless network wireless APs 141 or base stations 142 may be operatively connected to the information handling system 100. Network interface device 130 may include one or more radio frequency (RF) subsystems (e.g., radio 132) with transmitter/receiver circuitry, modem circuitry, one or more antenna RF front end circuits 134, one or more wireless controller circuits, amplifiers, antennas 136 and other circuitry of the radio 132 such as one or more antenna ports used for wireless communications via multiple radio access technologies (RATs). The radio 132 may communicate with one or more wireless technology protocols.

In an embodiment, the network interface device 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP 2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth ® protocols in some embodiments. Network interface device 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The network interface device 130 can represent an add-in card, wireless network interface module that is integrated with a main board of the information handling system 100 or integrated with another wireless network interface capability, or any combination thereof.

In some embodiments, one or more hardware processors or hardware controllers executing software, firmware, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software machine readable code instructions executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes machine-readable code instructions, parameters, and profiles 114 or receives and executes instructions, parameters, and profiles 114 responsive to a propagated signal, so that a hardware device connected to a network 140 may communicate voice, video, or data over the network 140. Further, the machine readable code instructions 114 may be transmitted or received over the network 140 via the network interface device or network interface device 130. The present disclosure also contemplates machine-readable code instructions, parameters, and profiles executing on a hardware controller 121 or 181 on-board the plural standalone digital display devices 120 and 180 and includes machine readable code instructions, parameters, and profiles of digital display device firmware or software to execute system and methods of the present disclosure.

The information handling system 100 may include a set of instructions 114 or digital display device firmware 125 that may be executed to cause the information handling system 100 or the OLED digital display device 120 to perform any one or more of the methods or computer-based functions disclosed herein. For example, machine readable code instructions 114 may be executed by a hardware processor 102, GPU 106, EC or any other hardware processing resource and may include software agents, or other aspects or components used to execute the methods and systems described herein. In another example, machine readable code instructions may be executed by a hardware controllers 121 or 181 or other hardware processing resource on-board plural standalone digital display devices 120 and 180 respectively for execution of digital display device firmware or software according to parameters and instructions at each of the plural standalone digital display devices 120 and 180 and as instructed by the information handling system 100 executing the display devices audio and display contextual engine system 111 or other software applications. Various software modules or firmware modules comprising application machine readable code instructions 114 may be coordinated by an OS 113, via operation of the OLED digital display device 120, and/or via an application programming interface (API) include a unified device API described herein. An example OS 113 may include Windows®, Android ®, and other OS types. Example APIs may include Win 32, Core Java API, or Android APIs.

In an embodiment, the information handling system 100 may include a disk drive unit 115. The disk drive unit 115 and may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106 or EC, or other microcontroller unit to perform the processes described herein. Similarly, main memory 103 and static memory 105 may also contain a computer-readable medium for storage of one or more sets of machine-readable code instructions, parameters, or profiles 114 described herein. The disk drive unit 115 or static memory 105 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 103, the static memory 105, and/or within the disk drive 115 during execution by the hardware processor 102, EC, or GPU 106 of information handling system 100.

Main memory 103 or other memory of the embodiments described herein may contain computer-readable medium (not shown), such as RAM in an example embodiment. An example of main memory 103 includes random access memory (RAM) such as static RAM (SRAM), dynamic RAM (DRAM), non-volatile RAM (NV-RAM), or the like, read only memory (ROM), another type of memory, or a combination thereof. Static memory 105 may contain computer-readable medium (not shown), such as NOR or NAND flash memory in some example embodiments. The applications and associated APIs, for example, may be stored in static memory 105 or on the disk drive unit 115 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 107 (a.k.a. a power supply unit (PSU). The PMU 107 may include a hardware controller and executable machine-readable code instructions to manage the power provided to the components of the information handling system 100 such as the hardware processor 102 and other hardware components described herein. The PMU 107 may control power to one or more components including the one or more drive units 115, the hardware processor 102 (e.g., CPU), the EC, the GPU 106, an integrated display device 191, or other wired I/O devices 190 and other components that may require power when a power button has been actuated by a user. In an embodiment, the PMU 107 may monitor power levels and be electrically coupled to the information handling system 100 to provide this power. The PMU 107 may be coupled to the bus 117 to provide or receive data or machine-readable code instructions. The PMU 107 may regulate power from a power source such as the battery 108 or AC power adapter 109. In an embodiment, the battery 108 may be charged via the AC power adapter 109 and provide power to the components of the information handling system 100, via wired connections as applicable, or when AC power from the AC power adapter 109 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 112 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

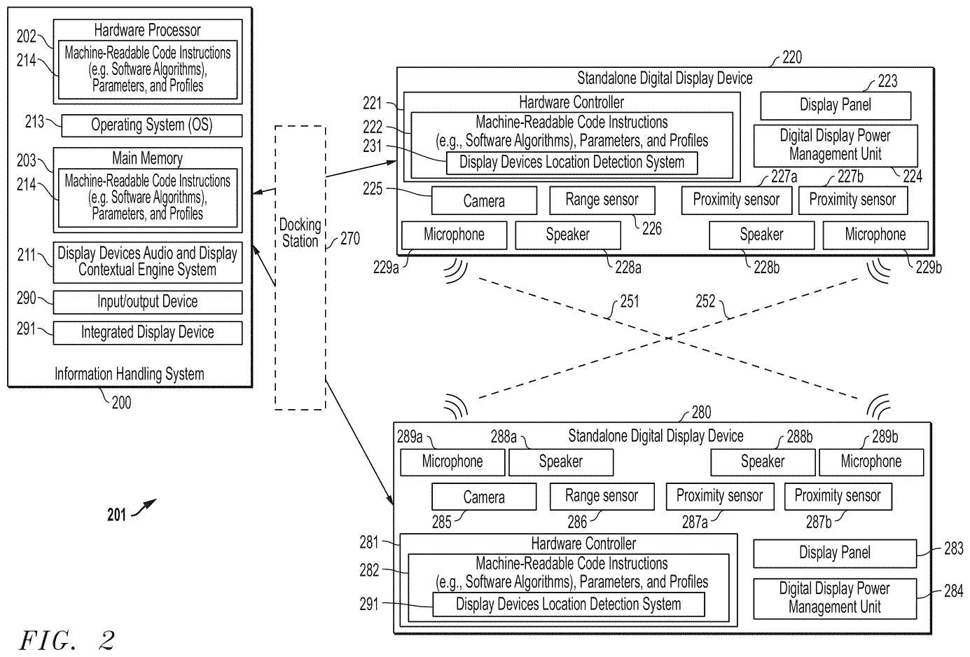

FIG. 2 is a block diagram illustrating a digital workspace including an information handling system executing machine readable code instructions a digital display devices audio and visual contextual engine system to operate a unified virtual adaptive user interface for automatic adjustment and tuning across plural standalone digital display devices and the information handling system, if active, in the digital workspace according to an embodiment herein. The digital workspace 201 may include plural standalone digital display devices 220 and 280 operatively coupled to an information handling system 200. In some embodiments, the digital workspace 201 may include plural standalone digital display devices 220 and 280 operatively coupled to an information handling system 200 via a docking station 270. In further embodiments herein, information handling system 200 itself, which includes an integrated display device 291, such as for a laptop-type or table-type information handling system, may be included in the unified virtual adaptive user interface for the digital workspace 201. For example, in some embodiments, the user may utilize the integrated display device 291 and input/output devices 290 of the information handling system 200, such when a laptop lid is open or a tablet is active and facing a user, as part of the digital workspace 201 according to embodiments herein. In other embodiments, such as when a laptop lid is closed or the tablet integrated display device 291 is not facing a user, one or more I/O devices 290 and the integrated display device 291 on the information handling system 200 may not be active and part of the unified virtual adaptive user interface for the digital workspace. Although the information handling system 200 is not active in the formed unified virtual adaptive user interface across the plural standalone digital display devices, it may still operate for processing software, firmware or the like for content as well as communications for use in the digital workspace 201 by the user according to embodiments herein.

The plural standalone digital display devices 220 and 280, as well as the information handling system 100, may include their own set of I/O devices or sensors. For example, a first standalone digital display device 220 may include a hardware controller 221, a display panel 223, a camera 225, one or more speakers 228a and 228b, one or more microphones 229a and 229b, one or more cameras 225 in an embodiment. The first standalone digital display device 220 may include other I/O devices or sensors such as a range sensor 226, which may be part of a camera 225 in some embodiments or a separate range sensor using infrared, sound, radiofrequency, light, or other wave sensing devices, and one or more proximity sensors 227a and 227b which may be side mounted in some embodiments. In one embodiment, the one or more proximity sensors 227a and 227b may be infrared (IR) proximity sensors. Additional I/O devices, sensors, or features on the first standalone digital device 220 are also contemplated within the digital workspace.

A second standalone digital display device 280 may include a hardware controller 281, a display panel 283, a camera 285, one or more speakers 288a and 288b, one or more microphones 289a and 289b, one or more cameras 285 in an embodiment. The second standalone digital display device 280 may include other I/O devices or sensors such as a range sensor 286, which may be part of a camera 285 in some embodiments or a separate range sensor 286, and one or more infrared (IR) proximity sensors 287a and 287b which may be side mounted in some embodiments. Additional I/O devices, sensors, or features on the second standalone digital device 280 are also contemplated within the digital workspace.

Further, the information handling system 200 may be active in some embodiments such that an integrated display device 291 is active as well as one or more input/output (I/O) devices 290 such as cameras, speakers, microphones or sensors onboard the information handling system 200. The above may cause redundancy of display panels and I/O devices and systems, or cause conflict in the operation of the display panels as well as the various input/output (I/O) sensors, such as microphones, speakers, or cameras, when operating in the digital workspace. Further, a user in the digital workspace may utilize any of the plural standalone digital display devices 220 or 280 or the information handling system 200 and its integrated display device 291 as a primary working system at any given time while others may be secondary based on a detected location of the user within the digital workspace accordingly. Upon attaching plural standalone digital display devices 220 and 280 to the information handling system 200 or a docking station 270 will typically require manual setup of each of the plural standalone digital display devices 220 and 280 and the information handling system 200, including the various I/O devices thereon in the digital workspace to accommodate viewing or audio for the location of the user.

In embodiments of the present disclosure, the information handling system 200 executing machine readable code instructions a digital display devices audio and visual contextual engine system 211 may detect the plural standalone digital display devices 220 and 280 as well as the active status of the information handling system 200 participating in the digital workspace. The information handling system 200 operates machine readable code instructions 214 to detect when plural standalone digital display devices 220 and 280 are operatively coupled to the information handling system 200 directly or via a docking station 270. For example, ports on the information handling system 200 or docking station 270 may detect that plural standalone digital display devices 220 and 280 have been plugged in and are active with the information handling system 200 in the digital workspace 201. In another example embodiment, the information handling system 200 may detect that a wireless interface adapter has wirelessly paired with the plural standalone digital display devices 220 and 280 such that they are active with the information handing system 200 in the digital workspace 201. The information handling system 200 executes machine readable code instructions 214 of a digital display devices audio and visual contextual engine system 211 to assess the IO devices of the plural standalone digital display device 220 and 280 in the digital workspace and unify operation of digital workspace I/O devices including plural display panels 223 and 283, microphones 229a, 229b, 289a and 289b, speakers 228a, 228b, 288a and 288b, and other I/O devices and sensors of the standalone digital display devices 220 and 280 as well as any active the information handling system 100. The digital display devices audio and visual contextual engine system 211 forms a superset of I/O devices in the digital workspace as unified digital workspace I/O devices for operation as a unified virtual adaptive user interface across the plural standalone digital display devices 220 and 280 and any active information handling system 200.

In a further embodiment, the information handling system 200 executes the digital display devices audio and visual contextual engine system 211 to automatically trigger machine readable code instructions of a digital devices location detection systems 231 and 291 to be executed by hardware controllers 221 and 281 at each of the detected the plural standalone digital display devices 220 and 280, respectively, upon detection that they are operatively coupled in the digital workspace. Such digital devices location detection systems 231 and 291 may not need to be activated when only one standalone digital display device (e.g., 220 or 280) is operatively coupled in some embodiments. It is contemplated, however, that any number of standalone digital display devices 220 and 280 or an integrated digital display 291 and I/O devices 290 of an active information handling system 200 may operate as the unified virtual adaptive user interface across the digital workspace 201 in various embodiments. In an example embodiment, one or more standalone digital display devices 220 or 280 and an integrated display device 291 and set of I/O devices 290 may be detected to form a unified virtual adaptive user interface. In embodiments herein, any plurality of standalone digital display devices 220 and 280 may be detected as operatively coupled, by wire or wirelessly, to the information handling system 200 to automatically trigger execution of digital devices location detection systems 231 and 291 at those standalone digital display devices 220 and 280 in embodiments herein.

A hardware controller 221 or 281 or other hardware processing resource on each of the plural standalone digital devices 220 or 280 executes the machine readable code instructions of the digital devices location detection system 231 or 291 thereon to utilize exchange of sound or infrared waves to automatically determine a location of each standalone digital display device 220 relative to other standalone digital display devices 280 and the information handling system 200, if active, within the digital workspace. For example, a first standalone digital display device 220 may execute a digital devices location detection system 231 utilize a first speaker 228a to play a tone or sound, such as a beep or an inaudible tone, from at least the first speaker 228a on the first standalone digital display device 220 in an embodiment. The hardware controller 221 will then send indication of the tone being played to the information handling system 200 on a control channel of the operative coupling. The information handling system 200 executing the digital display devices audio and visual contextual engine system 211 then coordinates with the second standalone digital display device 280 to execute its digital devices location detection system 291 to activate a first microphone 289a or plural microphones 289a and 289b to receive the tone played by the first standalone digital display device 220. The digital devices location detection system 291 then executes at the second standalone digital display device 280 to beamform the direction of the tone played from the single microphone 289a, if it is a beamforming microphone array, or plural microphones 289a and 289b at known locations on the second standalone digital display device 280 to identify the location direction and distance of the first standalone digital display device 220 relative to the second standalone digital display device 280 in an embodiment. The second standalone digital display 280 may have an orientation sensor to detect and report its orientation such that the beamforming data detected by the single beamforming microphone 289a or plural microphones 289a and 289b may identify a direction angle of the incoming tone sound waves relative to the orientation of the second standalone digital display device 280. In some embodiments, distance may be measured based on known time of triggering the tone at the speaker 228a to play.

In an example embodiment, one of the microphones, for example 289a, may be a beamforming microphone that includes an array of microphones at a location which may be used to detect a doppler shift or phase of sound with a beamforming algorithm to determine source location for beamforming identification of the location direction of the tone source and use that to determine the display panel rotation or angle relative to voice origination position. In another example embodiment, two microphones 289a and 289b, spaced on the chassis at known distance and angles of the second standalone digital display device 280, may be used to detect a doppler shift of sound received at both microphones 289a and 289b with execution of a beamforming algorithm to determine a beamforming direction of the source location of the sound. The second standalone digital display device 280 then reports location data of the first standalone digital display device 220, determined from the beamforming-determined direction and distance, to the digital display devices audio and visual contextual engine system 211 at the information handling system 200.

It is understood that additional information location data of the first standalone digital display device 220 may be determined by the hardware controller 221 of first standalone digital display device 220 causing a second tone to be played by speaker 228b. The digital display devices audio and visual contextual engine system 211 at the information handling system 200 may then receive notification of the second tone and coordinate the second standalone digital display device 280 to active a beamforming microphone 289a or plural microphones 289a and 289b to detect the second tone played. With the second tone from a second speaker 228a on the first information handling system 220, additional location information of the first standalone digital display device 220 may be determined with beamforming by the display device location detection system 291 as to direction and distance. This location information of the first standalone digital display device 220 may then be transmitted to the digital display devices audio and visual contextual engine system 211 at the information handling system 200 by the second standalone digital display device 280 in embodiments herein.

In a further embodiment, the second standalone digital display device 280 may execute machine readable code instructions of digital devices location detection system 291 to play a tone at a speaker 288a of the second standalone digital display device 280 in the digital workspace 201 and report playing of that tone to the digital display devices audio and visual contextual engine system 211 at the information handling system 200. This may trigger execution of the digital devices location detection system 231 at the first standalone digital display device 220 to detect the tone via one or more microphones 229a or 229b located at one or more known locations on the first standalone digital display device 220 in embodiments herein. The digital devices location detection system 231 then executes at the first standalone digital display device 220 to beamform the source of the tone via execution of a digital signal processing beamforming algorithm according to embodiments herein. The direction and distance of the source of the tone played may be determined via detection of doppler phase shift techniques to identify the location of the second standalone digital display device 280 relative to the first standalone digital display device 220 in an embodiment. The first standalone digital display 220 may also have an orientation sensor for its orientation such that the beamforming data may identify a direction and distance of the source tone location relative to an orientation of the first standalone digital display device 220. The first standalone digital display device 220 may then report the location data of the second standalone digital display device 280 to the digital display devices audio and visual contextual engine system 211 at the information handling system 200.

As before, for more accurate location and distance data of the second standalone digital display device 280 in the digital workspace, the process may be repeated with a tone played at a second speaker 288b at the second standalone digital display device 280 and detected by one or more microphones 229a or 229b at the first standalone digital display device 220. Known and reported distances and angle of locations between the first speaker 288a and second speaker 288b on the chassis of the second standalone digital display device 280 may be used to assessment of orientation of the second standalone digital display device 280. In further embodiments herein, this process may be repeated among any plurality of standalone digital display devices operatively coupled to the information handling system 200 upon their detection within the digital workspace 201 in embodiments herein. This process may include determination of location between any one standalone digital display device 220 and 280 and the information handling system 200 as well as any additional standalone digital display devices within the digital workspace. With location information received at the digital display devices audio and visual contextual engine system 211 at the information handling system 200, the digital display devices audio and visual contextual engine system 211 may then configure a mapping of the digital workspace from relative locations between the plural standalone digital display devices 220, 280 and the information handling system 200 in embodiments herein. With additional orientation sensor data of each of the plural standalone digital display devices 220, 280 and the known and reported location data information from two speakers 229a, 229b or 289a, 289b on the chasses of the plural standalone digital display devices 220, 280, the orientation or facing position of the display panels 223 and 283 for each of the plural standalone digital display devices 220, 280 may be determined within the digital workspace by the digital display devices audio and visual contextual engine system 211.

In another embodiment, the plural standalone digital display devices 220 and 280 may include proximity sensors 227a, 227b and 287a, 287b which may be side-mounted to each of the plural standalone digital display devices 220 and 280 respectively. In an embodiment, proximity sensors 227a, 227b and 287a, 287b may be infrared proximity sensors, but ultrasound, radiofrequency, ultra-wideband radiofrequency and other proximity sensor types are contemplated. The embodiment of FIG. 2 shows proximity sensors 227a, 227b and 287a, 287b that are infrared (IR) proximity sensors 227a, 227b and 287a, 287b. Since the plural digital display devices 220 and 280 are typically placed adjacent to one another when operatively coupled within a digital workspace, these proximity sensors 227a, 227b and 287a, 287b may be used on each standalone digital display device 220 and 280 to detect direction and location of other standalone digital display devices within the digital workspace 201 upon operatively coupling to the information handling system 200 in embodiments herein. The digital devices location detection system 231, for example, executes via a hardware controller 221 at a first standalone digital display device 220 to transmit infrared or other wave beams from one or more proximity detectors 227a and 227b and reports the same to the information handling system 200. The digital devices location detection system 291 executing at a second standalone digital display device 280 is notified of the infrared transmission and uses its side mounted proximity sensors 287a or 287b to detect from which direction and distance the infrared or other wave transmission comes from to identify the location of the first standalone digital display device 220 relative to the second standalone digital display device 280 in an embodiment. The second standalone digital display 280 may have an orientation sensor for its orientation such that the received side of the infrared transmission may identify a direction of the source infrared transmission relative to the second standalone digital display device 280. The second standalone digital display device 280 may then report the location data of the first standalone digital display device 220 to the digital display devices audio and visual contextual engine system 211 at the information handling system 200.

Similarly, in embodiments, the second standalone information handling system 280 may transmit an infrared signal with its side mounted infrared sensors 287a and 287b which may be detected by side mounted infrared sensors 227a or 227b at the first standalone digital display device 220. The first standalone digital display device 220 may then execute machine readable code instructions of the digital devices location detection system 231, for example, to identify location direction and distance of the second standalone digital display device 280 from the receipt of the infrared transmission at one of the side mounted infrared sensors 227a or 227b on the first standalone digital display device 220. The first standalone digital display device 220 may then report the location data of the second standalone digital display device 280 to the digital display devices audio and visual contextual engine system 211 at the information handling system 200.

Once the location direction, distance or orientation data, derived from either sound or infrared or other technologies (capacitive, camera, RF, sound/ultrasound) wave exchange, for each of the plural standalone digital display devices 220 and 280 within the digital workspace is received at the digital display devices audio and visual contextual engine system 211 at the information handling system 200, the digital display devices audio and visual contextual engine system 211 unifies operation of the plurality of I/O devices on the plural standalone digital display device 220 and 280 or the information handling system, if active, as a superset of unified digital workspace I/O devices and based on the location mapping of the digital workspace 201. The hardware processor 202, an embedded controller, or other hardware processing resource, unifies operation of digital workspace I/O devices including display panels 223 and 283, microphones 229a, 229b, 289a and 289b, speakers 228a, 228b, 288a and 288b, cameras 225 and 285, proximity sensors 227a, 227b, 287a and 287b, a range sensor 226 or 286 and other I/O sensor devices at the plural digital display devices 220 and 280 to operate as a unified virtual adaptive user interface for the digital workspace 201. In one example embodiment, the hardware processor 202 executing the digital display devices audio and visual contextual engine system 211 utilizes at least one camera system 225 or 285, one or more microphones 229a, 229b, 289a or 289b, a range sensor 226 or 286, or other sensor of the unified digital workspace I/O devices to identify and locate a user's location direction and distance from the plural standalone digital display devices 220 and 280 within the digital workspace 201 in embodiments herein.

The determination of the user location and direction of gaze may utilize execution of face recognition algorithms with image data from a camera 225 or 285 in an embodiment to identify a face and orientation of a user's face in one direction or another. Further determination of the user's location may be determined from one or more microphones 229a, 229b, 289a or 289b, a range sensor 226 or 286, or even a camera 225 or 285 with range sensing capabilities to determine with beamforming the location of a user's voice or a direction of a user relative to the two or more plural standalone digital display devices 220 and 280 within the digital workspace 201 in embodiments herein. Additionally, one or more microphones 229a, 229b, 289a or 289b, a range sensor 226 or 286, or even a camera 225 or 285 with range sensing capabilities may determine a user's distance from at least one standalone digital display device 220 or 280 within the digital workspace in embodiments herein. This user location information, including direction, distance, face orientation relative to one or more of the plural standalone digital display devices 220 or 280 may be reported back to the digital display devices audio and visual contextual engine system 211.

Upon determination of a location and orientation of a user within the digital workspace, the digital display devices audio and visual contextual engine system 211 executes to automatically adjust and tune operation of each of the standalone digital display devices 220 and 280 and their unified digital workspace I/O devices for audibility and viewability as part of the unified virtual adaptive user interface based on the location of the user relative to the location of the plural standalone digital display devices 220 and 280 in the digital workspace 201. The digital display devices audio and visual contextual engine system 211 executes to issue adjustment control commands to each standalone digital display device 220 and 280 to adjust or disable their unified digital workspace I/O devices as part of the unified virtual adaptive user interface for the user's location in the digital workspace 201 in embodiments herein. The digital display devices audio and visual contextual engine system 211 at the information handling system 200 issues commands to the unified digital workspace I/O devices including display panels 223 and 283, microphones 229a, 229b, 289a and 289b, speakers 228a, 228b, 288a and 288b, cameras 225 and 285, proximity sensors 227a, 227b, 287a and 287b, a range sensor 226 or 286 and other I/O sensor devices to disable I/O sensor devices that may conflict or to adjust settings of those I/O sensor devices for optimizing audibility and viewability for the user at the her detected location and gaze orientation within the digital workspace 201 in embodiments herein. Further, the digital display devices audio and visual contextual engine system 211 operating the unified digital workspace I/O devices including display panels 223 and 283, microphones 229a, 229b, 289a and 289b, speakers 228a, 228b, 288a and 288b, cameras 225 and 285, proximity sensors 227a, 227b, 287a and 287b, a range sensor 226 or 286 and other I/O sensor devices may detect the environment, such as ambient sound or lighting of the user or whether the user is in a public location context or private location context, to further tune the unified digital workspace I/O devices of the standalone digital display devices 220 and 280 for the user's location in the digital workspace in embodiments herein.

In other embodiments, the hardware processor 202 executing machine readable code instructions of a digital display devices audio and visual contextual engine system 211 may further incorporate the information handling system 200 and I/O devices 290 such as speakers, microphones, cameras, and other sensors as well as integrated digital display device 291 within the unified virtual adaptive user interface for the user in the digital workspace. In an embodiment, the digital display devices audio and visual contextual engine system 211 may detect when a laptop lid is open or a tablet display device is active to include an integrated display device 291, and any integrated I/O devices 290 such as microphones, speakers, cameras or the like onboard the information handling system 200 as part of the unified operation of the unified digital workspace I/O devices within the unified virtual adaptive user interface when the laptop lid is open. Location and direction of the information handling system 200 within the digital workspace and relative to the plural standalone digital display devices 220 and 280, as well as a user, may be determined according to embodiments as described herein. In other embodiments, when the laptop lid is closed, any of the integrated display device 291, and any integrated I/O devices 290 such as microphones, speakers, cameras or the like of the information handling system 200 may be disabled by the digital display devices audio and visual contextual engine system 211 from operation as part of the unified digital workspace I/O devices within the unified virtual adaptive user interface while others may be utilized for enhance function or context sensing within the digital workspace.

In an example embodiment, the location of the user may be used by the digital display devices audio and visual contextual engine system 211 to automatically turn off one or more microphones, 289a or 289b, at one standalone information handling system such as 280 and increase sensitivity of other microphones, 229a or 229b, on another standalone digital display device such as 220 based on proximity or distance from the user to reduce pickup of background noise or echo. In another example embodiment, the location of the user may be used by the digital display devices audio and visual contextual engine system 211 to automatically adjust content location or content magnification size among display panels 223 or 283 of the plural standalone digital display devices 220 and 280 or an integrated display panel 291 if active. In yet another example embodiment, the location of the user relative to the plural standalone digital display devices 220 and 280, and surrounding contextual data detected from other unified digital workspace I/O devices such as light levels by a camera 225, 285 or a light sensor, may be used by the digital display devices audio and visual contextual engine system 211 to automatically adjust contrast, brightness, or other viewability controls on display panels 223 and 283 at each of the plural standalone digital display devices 220 and 280 or at integrated display device 291 if active. In yet other embodiments, the location of the user relative to the plural standalone digital display devices 220 and 280, and detected surrounding contextual data detected from other unified digital workspace I/O devices such as microphone 229a, 229b, 289a, or 289b detecting ambient noise levels, may be used by the digital display devices audio and visual contextual engine system to automatically adjust speaker volumes at speakers 228a, 228b, 288a, or 288b or direction for audio content played from those speakers in the unified digital workspace I/O devices for the location of the user in the digital workspace. Similarly, ambient noise level data may also be used to determine sensitivity and directionality of microphones 229a, 229b, 289a, or 289b in the unified digital workspace I/O devices for the location of the user in the digital workspace in another embodiment. Additional examples of tuning of the unified digital workspace I/O devices of the unified virtual adaptive user interface at the digital workspace 201 are contemplated in various embodiments with the digital display devices audio and visual contextual engine system 211.

The hardware processor 202, or another hardware processing resource, executing machine readable code instructions 214 of the digital display devices audio and visual contextual engine system 211 to monitor the user's location with any one or more of the plurality of unified digital I/O devices of the unified virtual adaptive user interface at the digital workspace 201. The user's movement, such as head location or gaze direction, may be monitored continuously or periodically by the digital display devices audio and visual contextual engine system 211 and select sensors in the unified digital I/O devices of the unified virtual adaptive user interface. The digital display devices audio and visual contextual engine system 211 may determine movement distance by a user's head within the mapped digital workspace 201 among the plural standalone digital display devices 220 and 280 relative to a movement distance threshold. An example movement distance threshold may be 5 cm, 10 cm, or 30 cm although any movement distance threshold may be used depending on intended sensitivity. The determined movement distance threshold is used to eliminate smaller shifts or smaller movements by the user's head during operation with unified virtual adaptive user interface in the digital workspace 201.

In another embodiment, a timer may be used at the digital display devices audio and visual contextual engine system 211. When movement of the user is detected by any of the one or more unified digital workspace I/O devices or sensors that reaches a sufficient user movement threshold, a timer is started to determine whether the movement, such as of a user's head or face, is a temporary movement relative to a movement timing threshold. A movement timing threshold may be for 5 second, 15 seconds, 30 seconds, a minute or any other timing period duration in various embodiments and may be set based on a intended sensitivity for automatic adjustments to the unified virtual adaptive user interface. If threshold levels of movement occur by the user, the process described in embodiments herein for disabling, enabling, tuning or adjusting the unified digital workspace I/O devices within the unified virtual adaptive user interface may be repeated, and this may be dynamically repeated routinely for movements meeting the user movement threshold and movement timing threshold while the plural standalone digital display devices 220 or 280 and information handling system 200 are still powered on. If the relative locations of displays and user change in time (such as user sits closer or displays pushed away from one another or are rotated differently for a period or time (5 s, 10 s, 1 minute), the workstation readjusts its I/O functionality and I/O device setting levels (brightness, loudness, steering toward user) to maintain optimized interface options, optimized audibility settings, optimized viewability, illumination or the like.

In another embodiment, changes to the operative coupling of plural standalone digital display devices or the state of the information handling system 200 may be monitored. If the information handling system 200 display lid is opened or closed or the integrated display 291 otherwise is detected to become active or inactive from a previous state, the digital display devices audio and visual contextual engine system 211 executes to integrate or disable I/O devices 290 or the integrated display device 291 as part of the superset of unified digital workspace I/O devices within the unified virtual adaptive user interface in embodiments herein. Further, periodic monitoring, such as hourly, daily, or less often or detection of operative coupling or decoupling of any standalone digital display device with the information handling system 200 may trigger a reassessment of the digital workspace mapping by the digital display devices audio and visual contextual engine system 211 according to embodiments described herein relative to the changed standalone digital display device. This monitoring may also be dynamically repeated changes in the standalone digital display devices or the activity state of the integrated digital display 291 of the information handling system 200 while the plural standalone digital display devices 220 or 280 and information handling system 200 are still powered on.

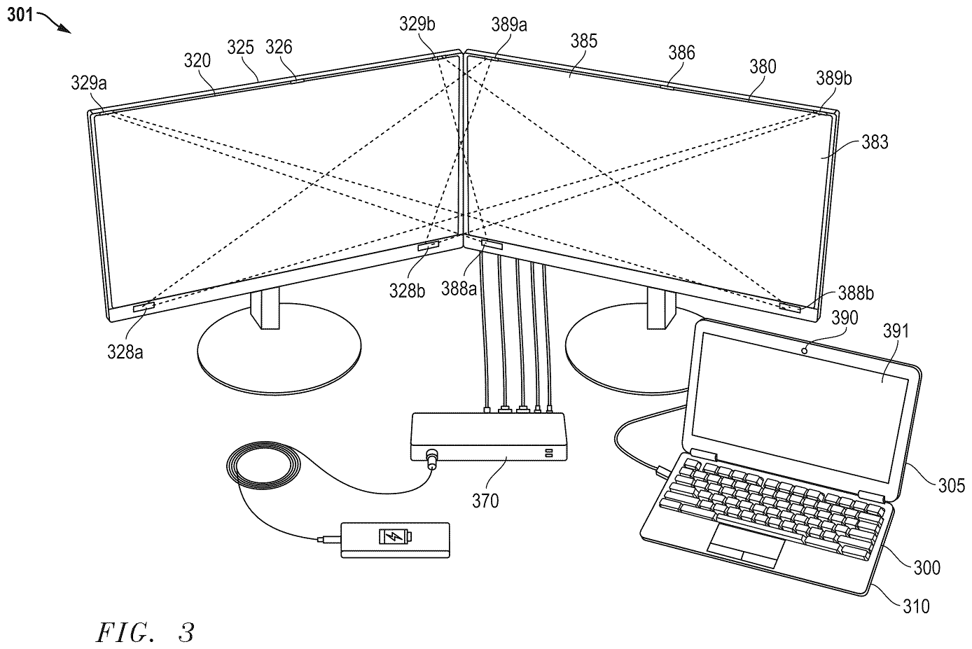

FIG. 3 is a graphical diagram illustrating a digital workspace including an information handling system executing machine readable code instructions a digital display devices audio and visual contextual engine system to operate a unified virtual adaptive user interface for automatic adjustment and tuning across plural standalone digital display devices and the information handling system in the digital workspace according to an embodiment herein. In embodiments of the present disclosure, the digital workspace 301 may include plural standalone digital display devices 320 and 380 that may automatically determine relative location to one another and any other standalone digital display devices in the digital workspace 301. In an embodiment, automatic determination of the locations of the plural standalone digital display devices 320 and 380 by an information handling system 300 occurs upon detecting operative coupling and activation of the plurality of standalone digital display devices 320 and 380 with the information handling system 300. The operatively coupling of the plural standalone digital display devices 320 and 380 may be wired or wirelessly coupled to the information handling system 300 in various embodiments. Further, the operative coupling of the plural standalone digital display devices 320 and 380 may be via a docking station 370 in embodiments herein which is detected by the information handling system 300. The information handling system 300 may execute machine readable code instructions of a digital display devices audio and visual contextual engine system to determine location of a user in the digital workspace 301 in embodiments herein and operate a plurality I/O devices on the plural standalone digital display devices 320 and 380 as a superset of unified digital workspace I/O devices with a unified virtual adaptive user interface according to embodiments herein.

In some embodiments, the information handling system 300, which includes an integrated display device 391 in a display laptop lid chassis, may be integrated by the digital display devices audio and visual contextual engine system to operate as part of the unified virtual adaptive user interface in the digital workspace 301 in embodiments herein. For example, a hall sensor, light sensor, camera or other I/O device 390 may operate as a sensor of the information handling system to detect when the display chassis lid 305 of the information handling system 300 is open with respect to the base chassis 310. In such an embodiment, the execution of the code instructions of the digital display devices audio and visual contextual engine system may integrate the integrated digital display device 391 and plurality of I/O devices 390, including any cameras, range or IR sensors, microphones, speakers, and other sensors of the information handling system, with the unified digital workspace I/O devices in embodiments herein. Further, the digital display devices audio and visual contextual engine system may determine the relative location of the information handling system 300 in the digital workspace 301 or trigger display devices location detection systems at one or more standalone digital devise to automatically detect location of the information handling system. In such an embodiment, the user may utilize the integrated display device 391 and input/output devices 390 of the information handling system 300 as part of the unified workspace I/O devices of unified virtual adaptive user interface for the digital workspace coordinated by the digital display devices audio and visual contextual engine system executing at the information handling system 300.

In other embodiments, a hall sensor, light sensor, camera or other I/O device 390 may detect when the display chassis lid 305 of the information handling system 300 is closed with respect to the base chassis 310 and one or more of the integrated display device 391 and input/output devices 390 of the information handling system 300 may be disabled from the unified digital workspace I/O devices used with the unified virtual adaptive user interface for the digital workspace. In such an embodiment, the information handling system 300 may still execute machine readable code instructions of the digital display devices audio and visual contextual engine system and other software applications and communications for the user to interact with the unified digital workspace I/O devices as the unified virtual adaptive user interface for the digital workspace across the plural standalone digital display devices 320 and 380. Further, in some embodiments, with a closed display lid, the information handling system camera or display panel may not be accessible, however the alternative sensors and systems that are still exposed with display chassis lid closed may still be integrated as part of the unified digital workspace I/O devices as part of the unified virtual adaptive user interface in some embodiments.

The first and second standalone digital display devices 320 and 380 as well as the information handling system 100 may include their own set of I/O devices or sensors. In one example embodiment, standalone digital display device 320 may include a display panel 323, a camera 325, a range sensor 326, which may be part of camera 325, a first speaker 328a, a second speaker 328b, a first microphone 329a and a second microphone 329b. In another example embodiment, standalone digital display device 380 may include a display panel 383, a camera 385, a range sensor 386, a first speaker 388a, a second speaker 388b, a first microphone 389a and a second microphone 389b in addition to other I/O devices or sensors. The first standalone digital display device 320 may be placed in a digital workspace at a first location and the second standalone digital display device 380 at a second location relative to the first standalone digital display device 320. According to embodiments herein, upon operative connectivity of the first standalone digital display device 320 and the second standalone digital display device 380 to the information handling system 300, the information handling system executes code instructions of the digital display devices audio and visual contextual engine system to trigger the digital display devices location systems at each of the standalone digital display devices 320 and 380 to commence determination of location with respect to one another.

The digital display devices location system at the first standalone digital display device 320, as coordinated by the digital display devices audio and visual contextual engine system, may play a tone, such as a beep, constant tone, inaudible tone or other, at speaker 1 328a. Speaker 1 328a may have a known location on the first standalone digital display device 320 that is reported to the digital display devices audio and visual contextual engine system. The digital display devices audio and visual contextual engine system then coordinates with the digital display devices location system at the second standalone digital display device 380 to receive the audio tone at microphone 1 389a and microphone 2 389b as depicted by the dashed line therebetween in an embodiment. The hardware controller of the second standalone digital display device 380 will execute a beamforming algorithm of the digital display devices location system according to embodiments herein with the microphone 1 389a and microphone 2 389b to determine a direction of the tone from speaker 1 328a of the first standalone digital display device 320. Further, the beamforming algorithm of the digital display devices location system at the second standalone digital display device 380 may determine a distance of the tone from speaker 1 328a of the first standalone digital display device 320 in some embodiments. In yet other embodiments, either microphone 1 389a and microphone 2 389b may be a beamforming microphone array in some embodiments and may be capable of providing sound capture data for beamforming direction or distance on its own. Any of several digital audio signal processing beamforming algorithms may be executed to detect doppler or phase shifting of the sound captured by a single microphone array at one microphone 389a or 389b or plural microphones 389a or 389b at the second standalone digital display device 380. This location data of the first standalone digital display device 320, as determined from the beamforming data as determined from the captured tone by the microphones 389a and 389b, may be sent from the second standalone digital display device 380 to the digital display devices audio and visual contextual engine system at information handling system 300.

In some embodiments, additional location data for the first standalone digital display device 320 may be used for orientation or to confirm location of the first standalone digital display device 320 within the digital workspace 301. The digital display devices location system at the first standalone digital display device 320, as coordinated by the digital display devices audio and visual contextual engine system, may play a second tone, such as a beep, constant tone, inaudible tone or other, from speaker 2 328b on the first standalone digital display device 320. Speaker 2 328b may also have a known location angle relative to and distance from speaker 1 328 on the first standalone digital display device 320 that is reported to the digital display devices audio and visual contextual engine system. The digital display devices audio and visual contextual engine system then coordinates with the digital display devices location system at the second standalone digital display device 380 to receive the audio tone at microphone 1 389a and microphone 2 389b as depicted by the dashed line therebetween in an embodiment. The hardware controller of the second standalone digital display device 380 will again execute a beamforming algorithm of the digital display devices location system according to embodiments herein with sound captured at microphone 1 389a and microphone 2 389b to determine a direction of the tone from speaker 2 328b of the first standalone digital display device 320. Further, the beamforming algorithm of the digital display devices location system at the second standalone digital display device 380 may determine a distance of the tone from speaker 2 328b of the first standalone digital display device 320 in some embodiments. In yet other embodiments, either microphone 1 389a or microphone 2 389b may be a beamforming microphone array in some embodiments and may be capable of providing sound capture data for beamforming direction or distance on its own.

This location data of the first standalone digital display device 320, as determined from the beamforming data as determined from the captured tone by the microphones 389a and 389b, may then be sent from the second standalone digital display device 380 to the digital display devices audio and visual contextual engine system at information handling system 300. With the known distance and angle between speaker 1 328a and speaker 2 328b, the orientation angle of the first standalone digital display device 320 may be determined within the mapping of the digital workspace by the digital display devices audio and visual contextual engine system at information handling system 300 in embodiments herein.

In an embodiment, the location and orientation data may also be determined for the second standalone digital display device 380 within the digital workspace 301. The digital display devices location system at the second standalone digital display device 380, as coordinated by the digital display devices audio and visual contextual engine system, may play a tone at speaker 1 388a, such as a beep, constant tone, inaudible tone or other. Speaker 1 388a has a known and reported location on the second standalone digital display device 380. The digital display devices audio and visual contextual engine system then coordinates with the digital display devices location system at the first standalone digital display device 320 to receive the audio tone at microphone 1 329a and microphone 2 329b as depicted by the dashed line therebetween in an embodiment. The hardware controller of the first standalone digital display device 320 will execute a beamforming algorithm of the digital display devices location system according to embodiments herein with the microphone 1 329a and microphone 2 329b to determine a direction of the tone from speaker 1 388a of the second standalone digital display device 380. Further, the beamforming algorithm of the digital display devices location system at the first standalone digital display device 320 may determine a distance of the tone from speaker 1 388a of the second standalone digital display device 380 in some embodiments. In yet other embodiments, either microphone 1 389a and microphone 2 389b may be a beamforming microphone array capable of providing sound capture data for beamforming direction or distance on its own. This location data of the second standalone digital display device 380, as determined from the beamforming data as determined from the captured tone by the microphones 329a and 329b, may be sent from the first standalone digital display device 320 to the digital display devices audio and visual contextual engine system at information handling system 300.

In some embodiments, additional location data for the second standalone digital display device 380 may be used for orientation or to confirm location of the second standalone digital display device 380 within the digital workspace 301. The digital display devices location system at the second standalone digital display device 380, as coordinated by the digital display devices audio and visual contextual engine system, may play a tone, such as a beep, constant tone, inaudible tone or other, at speaker 2 388b. Speaker 2 388b has a known and reported location angle and distance relative to speaker 1 388a on the second standalone digital display device 380. The digital display devices audio and visual contextual engine system then coordinates with the digital display devices location system at the first standalone digital display device 320 to receive the audio tone at microphone 1 329a and microphone 2 329b as depicted by the dashed line therebetween in an embodiment. The hardware controller of the first standalone digital display device 320 will again execute a beamforming algorithm of the digital display devices location system according to embodiments herein with sound captured at microphone 1 329a and microphone 2 329b to determine a direction of the tone from speaker 2 388b of the second standalone digital display device 380. Further, the beamforming algorithm of the digital display devices location system at the first standalone digital display device 320 may determine a distance of the tone from speaker 2 388b of the second standalone digital display device 380 in some embodiments. This location data of the second standalone digital display device 380, as determined from the beamforming data as determined from the captured tone by the microphones 329a and 329b, may then be sent from the first standalone digital display device 320 to the digital display devices audio and visual contextual engine system at information handling system 300. With the known distance and angle between speaker 1 388a and speaker 2 388b, the orientation angle of the second standalone digital display device 380 may be determined within the digital workspace by the digital display devices audio and visual contextual engine system at information handling system 300 in embodiments herein.

As described in embodiments herein, the information handling system 300 executes the digital display devices audio and visual contextual engine system to unify the various I/O devices 323, 383, 325, 385, 326, 386, 328a, 328b, 388a, 388b, 329a, 329b, 389a, 389b and other I/O devices and sensors of the plural standalone digital display devices 320 and 380 as unified digital workspace I/O devices. These unified digital workspace I/O devices are then configured for operation as a unified virtual adaptive user interface with automatic adjustment and tuning of those unified digital workspace I/O devices in the digital workspace 301 relative to a detected user's location in the digital workspace 301. In an example embodiment, the user may be detected via operation of any subset of the unified digital workspace I/O devices as to location, facing gaze direction, distance and other determinations relative to the plural standalone digital display devices 320 and 380 or any active information handling system 300. With this user location determined, the information handling system 300 executes the digital display devices audio and visual contextual engine system to adjust, disable, or otherwise tune the various I/O devices 323, 383, 325, 385, 326, 386, 328a, 328b, 388a, 388b, 329a, 329b, 389a, 389b and other I/O devices and sensors of the plural standalone digital display devices 320 and 380 to coordinate settings for the user's location. This may avoid redundancy of I/O device operation, or conflicts in the operation of the various I/O devices, such as microphones, speakers, or cameras across the plural standalone digital display devices 320 and 380 when operating in the digital workspace. Further, adjustments, disabling, or other tuning across the various I/O devices 323, 383, 325, 385, 326, 386, 328a, 328b, 388a, 388b, 329a, 329b, 389a, 389b and other I/O devices and sensors of the plural standalone digital display devices 320 and 380 of the unified digital workspace I/O devices may be conducted to adjust audibility and viewability for the user at the detected user's location within the digital workspace 301 according to embodiments herein. Detection of ambient conditions by any of the unified digital workspace I/O devices may further affect such adjustments, disabling, or tuning changes for optimizations of audibility and viewability for the user at the detected user's location within the digital workspace 301 according to embodiments herein. In an embodiment, a user may be located in front of the installed standalone digital display devices 320 and 380 as well as the information handling system 300 if the display chassis lid 305 is open.

For example, a user's location and facing posture or gaze direction detected as closer to the first standalone digital display device 320 than the second standalone digital display device 380 and the information handling system 300 may cause the digital display devices audio and visual contextual engine system to automatically tune the sensitivity and sound beamforming directionality of microphones 329a and 329b to be increased and directed to the user in an embodiment. Microphones 389a and 389b and a microphone at the information handling system 300 may be disabled or have sensitivity reduced in other embodiments. Similar automatic adjustments to speakers 329a and 329b may be made by the digital display devices audio and visual contextual engine system in terms of volume or even sound direction. Other speakers 389a and 389b and any speakers at the information handing system 300, of active, may be reduced or disabled in some embodiments or increased for a surround sound effect in other embodiments. Additional automatic adjustments and tuning to digital display panels 323 and 383 as well as the integrated digital display device 391 if active, may be made for contrast, brightness, sharpness, color, or display zoom depending on location and direction of the user and any detected lighting conditions at the user's location and vantage point. Similar automatic contextual adjustments may be executed by the digital display devices audio and visual contextual engine system to content displayed on the digital display panels 323 and 383 as well as the integrated digital display device 391 if active, generated from executing software applications relating to location of content among the display panels 323, 383, or 391 as well as magnification size and other aspects of content presented based on the user's detected location within the digital workspace relative to the plural standalone digital display devices 320 or 380 or the information handling system according to embodiments herein.

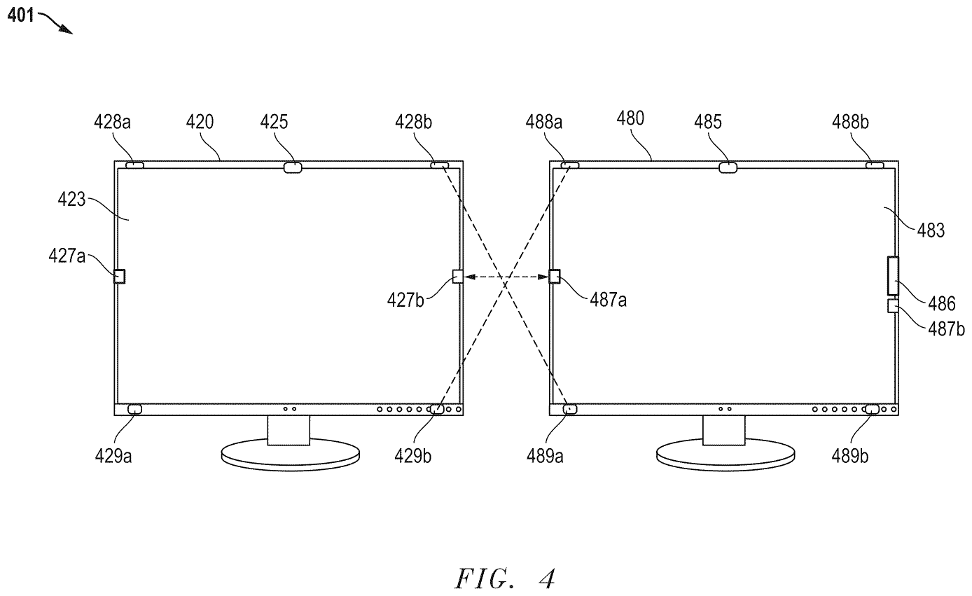

FIG. 4 is a graphical diagram illustrating a digital workspace including automatic detection of plural standalone digital display device location with infrared wave exchange for automatic adjustment and tuning across the plural standalone digital display devices for a unified virtual adaptive user interface in the digital workspace according to another embodiment of the present disclosure. Plural standalone digital display devices 420 and 480 are depicted in a digital workspace 401. In one example embodiment, first standalone digital display device 420 may include a display panel 423, a camera 425, a first speaker 428a, a second speaker 428b, a first microphone 429a, a second microphone 429b and a first infrared (IR) transmitter 427a and a second IR receiver 427b and other I/O devices or sensors. First infrared (IR) transmitter 427a and a second IR receiver 427b are side mounted on the standalone digital display device 420 and it is understood that the location of the first infrared (IR) transmitter 427a and a second IR receiver 427b may be switched but should remain consistent across standalone digital display devices. In other embodiments, first infrared (IR) transmitter device 427a may also be a receiver and a second IR receiver 427b may also be a transmitter.

In another example embodiment, second standalone digital display device 480 may include a display panel 483, a camera 485, a first speaker 488a, a second speaker 488b, a first microphone 489a and a second microphone 489b in addition to other I/O devices or sensors. First infrared (IR) transmitter 487a and a second IR receiver 487b are side mounted on the standalone digital display device 480 and it is understood that the location of the first infrared (IR) transmitter 487a and a second IR receiver 487b may be switched but should remain consistent across standalone digital display devices. In other embodiments, first infrared (IR) transmitter device 487a may also be a receiver and a second IR receiver 487b may also be a transmitter. The first standalone digital display device 420 may be placed in a digital workspace at a first location and the second standalone digital display device 480 at a second location relative to the first standalone digital display device 420.

The embodiment of FIG. 4 also shows a side proximity sensor 486 on the second standalone digital display device 480 which may use an infrared sensor, a Hall effect magnetic field sensor, a capacitive range sensor, an ultrawide band UWB sensor, a camera sensor or range sensor to determine another standalone digital display device or other device to the right of the second standalone digital display device 480 in some embodiments. Side proximity sensor 486 may not need a counterpart receiver device at the other standalone digital display device or other device in some embodiments to determine a direction or range of another standalone digital display device or information handling system on the side of the second standalone digital display device 480 with the side proximity sensor 486 to which it is mounted in some embodiments.

According to embodiments herein, upon operative connectivity of the first standalone digital display device 420 and the second standalone digital display device 480 to the information handling system, the information handling system executes code instructions of the digital display devices audio and visual contextual engine system to trigger the digital display devices location systems at each of the standalone digital display devices 420 and 480 to commence determination of location with respect to one another in the digital workspace 401.

In an embodiment, the plural standalone digital display devices 420 and 480 may include infrared or other wave-driven proximity sensors such as first infrared (IR) transmitter 427a and a second IR receiver 427b side mounted on the first standalone digital display device 420 and first infrared (IR) transmitter 487a and a second IR receiver 487b side mounted on the second standalone digital display device 480. The digital devices location detection system, for example, executes at a first standalone digital display device 420 to transmit infrared beams from one or more infrared proximity sensors 427a and 427b and reports the transmission to the information handling system. The digital devices location detection system executing at a second standalone digital display device 480 is notified of the infrared transmission and uses its side mounted infrared proximity sensors 487a or 487b, as depicted by the dotted line in FIG. 4, to detect from which direction and distance the infrared transmission comes from to identify the location of the first standalone digital display device 420 relative to the second standalone digital display device 480 in an embodiment. The second standalone digital display device 480 may then report the location data of the first standalone digital display device 420 to the digital display devices audio and visual contextual engine system at the information handling system.

Similarly, in some embodiments, the second standalone information handling system 480 may transmit an infrared signal from infrared proximity sensors 487a and 487b which may be detected by side mounted infrared sensors 427a or 427b at the first standalone digital display device 420 as depicted by the dotted line in FIG. 4. The first standalone digital display device 420 may then execute machine readable code instructions of the digital devices location detection system, for example, to identify location direction and distance of the second standalone digital display device 480 from the receipt of the infrared transmission. The first standalone digital display device 420 may then report the location data of the second standalone digital display device 480 to the digital display devices audio and visual contextual engine system at the information handling system. Similar operation to the above embodiments is contemplated with ultra-wide band radiofrequency, radiofrequency, ultrasonic, capacitive, or other wave driven side-mounted proximity sensors in place of side mounted infrared proximity sensors 427a and 427b and infrared proximity sensors 487a or 487b according to embodiments herein.

Once the location data for each of the plural standalone digital display devices 420 and 480 within the digital workspace 401 is received at the digital display devices audio and visual contextual engine system at the information handling system, the hardware processor unifies operation of digital workspace I/O devices including display panels 423, 483, microphones 429a, 429b, 489a, 489b, speakers 428a, 428b, 488a, 488b, cameras 425, 485, infrared proximity sensors 427a, 427b, 487a, 487b, and other I/O sensors (e.g. 486) at the plural digital display devices 420 and 480 to operate as a unified virtual adaptive user interface for the digital workspace 401 according to embodiments herein. For example, the hardware processor executing the digital display devices audio and visual contextual engine system utilizes at least one camera system, one or more microphones, a range sensor or other sensor of the unified digital workspace I/O devices to identify and locate a user's direction and distance from the plural standalone digital display devices 420 and 480 within the digital workspace 401 in embodiments herein. Upon determination of a location of a user within the digital workspace 401, the digital display devices audio and visual contextual engine system executes to automatically adjust and tune operation of each of the standalone digital display devices 420 and 480 and their unified digital workspace I/O devices as part of the unified virtual adaptive user interface based on the location of the user relative to the location of the plural digital display devices 420 and 480 in the digital workspace 401 according to embodiments herein.

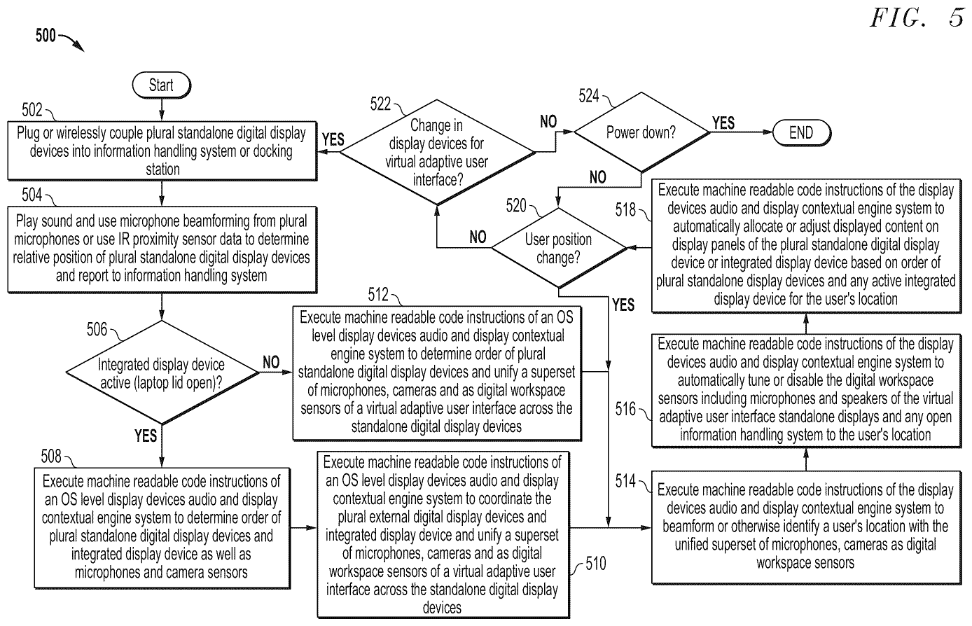

FIG. 5 is a flow diagram illustrating a method of executing machine readable code instructions of a digital display devices audio and visual contextual engine system to initiate automatic location determination of plural standalone digital display devices and operate a unified virtual adaptive user interface for automatic adjustment and tuning across the plural standalone digital display devices and an information handling system in a digital workspace according to an embodiment of the present disclosure. As described in embodiments herein, when plural standalone digital display devices are detected as being operatively coupled to an information handling system, a user is setting up a digital workspace according to embodiments herein. To avoid the need to configure each of the plural standalone digital display devices and the information handling system along with their plurality of I/O devices and sensors, embodiments of the present disclosure include execution of digital display devices audio and visual contextual engine system to coordinate automatic execution of machine readable code instructions of digital display devices location detection systems at each of the plural digital display devices to determine their respective locations within the digital workspace. Further, the digital display devices audio and visual contextual engine system unifies the plurality of I/O devices across the plural standalone digital display devices and the information handling system, where applicable, as a super set of unified digital workspace I/O devices operating or being activated and tuned in coordination as a unified virtual adaptive user interface in the digital workspace according to embodiments of the present disclosure.

At block 502, the hardware processor of an information handling system may detect operative coupling of plural standalone digital display devices with the information handling system. This may include detecting one or more standalone digital display devices being plugged into ports on the information handling system and detected by a port controller or network interface device in an embodiment. In other embodiments, one or more standalone digital display devices may be detected as being wirelessly coupled to a wireless interface adapter at the information handling system. In yet other embodiments, the one or more standalone digital display devices may be operatively coupled to a docking station in the digital workspace via wired or wireless coupling and detected as operatively coupled to the information handling system in the digital workspace. Operatively coupling of the plural standalone digital display devices via wired operative coupling or wireless operative coupling is reported to a digital display devices audio and visual contextual engine system executing at the information handling system.

Upon detection of plural standalone digital display devices being operatively coupled to form a digital workspace with the information handling system, the information handling system executes machine readable code instructions of the digital display devices audio and visual contextual engine system to initiate automatic location determination at each of the plural standalone digital display devices at block 504. The digital display devices audio and visual contextual engine system may transmit a command to each of the hardware controllers at each of the plural standalone digital display device to initiate exchange of sound, infrared or other waves to determine locations of each of the plural standalone digital display devices relative to one another in the digital workspace. At each detected standalone digital display device, a hardware controller at each of the plural standalone digital display devices executes machine readable code instructions of a digital displays location detection system in coordination with the digital display devices audio and visual contextual engine system at the information handling system. As described in one embodiment herein, a speaker at a known location on the first standalone digital display device is triggered to play a tone and this is coordinated by the digital display devices audio and visual contextual engine system with the second standalone digital display device to activate a beamforming microphone or plural microphones to detect the played tone. The digital displays location detection system at the second standalone digital display device executes a beamforming algorithm to detect a doppler shift of the received tone at each microphone or at the beamforming microphone to determine a direction and distance of the source of the tone from the speaker at the first standalone digital display device based on distance between the microphones according to embodiments herein. Example beamforming algorithms executed by the display devices location system may include simple beamforming algorithms such as used with digital signal processing, for example a delay and summation algorithm for received sound of the tone from at least two microphones or a microphone array to determine a source direction of the tone. Other example beamforming algorithms may include steered-response power (SRP) or steered-response power with phase transform (SRT-PHAT) beamforming in embodiments herein. Any of several audio beamforming algorithms may be used in embodiments herein. Since the standalone digital display devices are typically situated on a table or another relatively planar surface, beamforming techniques for direction or distance of the standalone digital display devices relative to one another are largely in a horizontal direction. Thus, the array of microphones used may be smaller in some embodiments since some directions, such as down or up, are less critical for tracking beamforming directionality.

In some embodiments, a second tone may be played at a second speaker having a known location on the first standalone digital display device by the digital displays location detection system. The digital display devices audio and visual contextual engine system then coordinates the microphones at the second standalone digital display device to record the tone and conduct beamforming of direction and distance to the source of the second tone at the speaker on the first digital display device. This second determination of direction and distance from the second speaker at a known location may also be used with the first report of direction and distance from the first speaker at another known location to determine an orientation of the first standalone digital display device in the digital workspace.

Similarly, the second and other standalone digital display devices may exchange one or more tones played at one or more speakers and detected by plural microphones at the first standalone digital display device to determine direction and distance for determination of a location direction, distance, or orientation of that second or other standalone digital display device by execution of a beamforming algorithm at the recipient first standalone digital display device. The exchange of tones and detection by plural microphones may automatically occur among any two pairs of standalone digital display devices that are detected as operatively coupled to the information handling system within the digital workspace and be coordinated by the digital display devices audio and visual contextual engine system executing at the information handling system. All location data of relative directions and distances of plural standalone digital display devices determined from exchange of tones and beamforming algorithms is reported to the digital display devices audio and visual contextual engine system for determination of relative locations of these plural standalone digital display devices and any active information handling system within the digital workspace.

In yet other embodiments, exchange of infrared sensor signals between side mounted infrared sensors between each pair of plural standalone digital display devices may be used by the digital displays location detection systems coordinated by the digital display devices audio and visual contextual engine system to determine direction and distance of each of the standalone digital display devices in a pair relative to one another according to embodiments herein. As described, the side mounted location of the infrared sensor receiving an infrared signal at a standalone digital display device may determine a direction of an infrared transmission source at another standalone digital display device in some embodiments herein. This direction and distance data may then be reported to the digital display devices audio and visual contextual engine system at the information handling system for determination of relative locations of the plural standalone digital display devices within the digital workspace.

In embodiments herein, with the location information reported, the digital display devices audio and visual contextual engine system may determine a relative mapping of the plural standalone digital display devices within the digital workspace from either microphone beamforming from sound tones or from infrared signal exchange via infrared sensor devices from infrared exchanged among the plurality of standalone digital display devices detected in the digital workspace.

At block 506, the information handling system may detect whether an integrated display device is active at the information handling system. For example, in an embodiment, a hall sensor system, light detector, hinge sensor, motion sensor, orientation sensor, or other sensor at the information handling system may detect whether a display device chassis lid is open or not. In another example embodiment, motion sensor, orientation sensor, or other sensor may detect orientation of a tablet type information handling system to determine of an integrated display device is viewable and active. If at block 506, the integrated display device is active at the information handling system, such as the display lid is open or the tablet is oriented for viewing, then flow may proceed to block 508. If at block 506, the integrated display device is not active at the information handling system, then flow may proceed to block 512.

At block 508, the hardware processor of the information handling system executes code instructions of the digital display devices audio and visual contextual engine system to determine a location of the information handling system relative to the one or more plural standalone digital display devices in the digital workspace. For example, speaker at the information handling system may play a tone that is detected by plural microphones at one or more standalone digital display devices operatively coupled in the digital workspace. The digital displays location detection system at the one or more standalone digital display devices may execute beamforming algorithms to determine location information of the information handling system relative to those one or more standalone digital display devices. It is contemplated that the reverse may also occur with the one or more standalone digital display devices playing a tone detected by microphone at the information handling system. Further, infrared sensors, range finder, camera sensor or other sensors may be used to determine location of the active information handling system in the digital workspace.

With the active information handling system as an active part of the digital workspace, the hardware processor of the information handling system may execute the digital display devices audio and visual contextual engine system to assess mapping of the plural standalone digital display devices and the integrated display device of the information handling system to determine an order of the locations of those plural standalone digital display devices and the integrated display device, such as a left to right order across the digital workspace. Such an order may be part of the mapping of the digital workspace by the digital display devices audio and visual contextual engine system of the locations of the plural standalone digital display devices and the integrated display device and may be used, for example, in stitching images together of an extended desktop and in selection of location of displayed content of the automatically established unified virtual adaptive user interface. Further, the digital display devices audio and visual contextual engine system conducts an assessment of the number and the order of the I/O devices such as various cameras, speakers, microphones, and other devices on the standalone digital display devices and the active information handling system.

Proceeding to block 510, the information handling system may execute the digital display devices audio and visual contextual engine system to assess the number of and the order or location of a plurality of I/O devices such as various cameras, speakers, microphones, and other devices on the standalone digital display devices and on the active information handling system in the digital workspace. As described in embodiments herein and with respect to FIG. 3, the information handling system 300 executes the digital display devices audio and visual contextual engine system to unify the various I/O devices 323, 383, 325, 385, 326, 386, 328a, 328b, 388a, 388b, 329a, 329b, 389a, 389b and other I/O devices and sensors of the plural standalone digital display devices 320 and 380 as well as the I/O devices 390 and 391 of the active information handling system as unified digital workspace I/O devices. These unified digital workspace I/O devices are operated, via control with the digital display devices audio and visual contextual engine system, as a unified virtual adaptive user interface for automatic adjustment and tuning of those unified digital workspace I/O devices in the digital workspace relative to a detected user's location in the digital workspace.

In an example embodiment, the user may be detected via operation of any subset of the unified digital workspace I/O devices as to location, facing direction, distance and other determinations relative to the plural standalone digital display devices and the active information handling system as discussed below with respect to block 514 at any time. With this user location determined, the information handling system executes the digital display devices audio and visual contextual engine system to adjust, disable, or otherwise tune the various I/O devices, such as 323, 383, 325, 385, 326, 386, 328a, 328b, 388a, 388b, 329a, 329b, 389a, 389b, 390, and 391 of FIG. 3 or other I/O devices and sensors of the plural standalone digital display devices 320 and 380 and active information handling system 300 to coordinate their settings or disable redundant I/O devices for the user's location. This may avoid redundancy of I/O device operation, or conflicts in the operation of the various I/O devices, such as microphones, speakers, or cameras across the plural standalone digital display devices and the active information handling system when operating in the digital workspace. Further, adjustments, disabling, or other tuning across the various I/O devices and sensors of the plural standalone digital display devices and the active information handling system of the unified digital workspace I/O devices may be conducted to adjust audibility and viewability for the user at the detected user's location within the digital workspace according to embodiments herein. Detection of ambient conditions by any of the unified digital workspace I/O devices may further affect such adjustments, disabling, or tuning changes for optimizations of audibility and viewability for the user at the detected user's location within the digital workspace according to embodiments herein. Flow may then proceed to block 514.

Returning to block 512, when the integrated display device of the information handling system is not active, for example the display lid is not open or the tablet information handling system is not oriented for viewing and active, the I/O devices on the information handling system such as the integrated display, and any one of the other on-board I/O devices such as cameras or other sensors or I/O devices may be disabled and not included as part of the unified virtual adaptive user interface across the plural standalone digital display devices in the digital workspace. Further, microphones and speakers may also be disabled when these are near a noise source as captured by contextual engine but not otherwise in some embodiments in the digital workspace. Nonetheless, the information handling system may still execute machine readable code instructions of the digital display devices audio and visual contextual engine system as well as other software applications for presenting audio and video content as well as conducting communications via the plurality of standalone digital display devices identified and mapped within the digital workspace in embodiments herein.

The information handling system executes the digital display devices audio and visual contextual engine system to assess the number and the order or location of a plurality of I/O devices such as various cameras, speakers, microphones, and other devices on the standalone digital display devices in the digital workspace.

As described in embodiments herein and with respect to FIG. 3, the information handling system 300 executes the digital display devices audio and visual contextual engine system to unify the various I/O devices 323, 383, 325, 385, 326, 386, 328a, 328b, 388a, 388b, 329a, 329b, 389a, 389b and other I/O devices and sensors of the plural standalone digital display devices 320 and 380, but not the one or more selected I/O devices 390 and integrated display device 391 of the information handling system, as unified digital workspace I/O devices. These unified digital workspace I/O devices are operated, via control with the digital display devices audio and visual contextual engine system, as a unified virtual adaptive user interface for automatic adjustment and tuning of those unified digital workspace I/O devices in the digital workspace relative to a detected user's location in the digital workspace.

In an example embodiment, the user may be detected via operation of any subset of the unified digital workspace I/O devices as to location, facing direction, distance and other determinations relative to the plural standalone digital display devices and the active information handling system as discussed below with respect to block 514 at any time. With this user location determined, the information handling system executes the digital display devices audio and visual contextual engine system to adjust, disable, or otherwise tune the various I/O devices, such as 323, 383, 325, 385, 326, 386, 328a, 328b, 388a, 388b, 329a, 329b, 389a, and 389b of FIG. 3 or other I/O devices and sensors of the plural standalone digital display devices 320 and 380 and active information handling system 300 to coordinate their settings or disable redundant I/O devices for the user's location. This may avoid redundancy of I/O device operation, or conflicts in the operation of the various I/O devices, such as microphones, speakers, or cameras across the plural standalone digital display devices operating in the digital workspace. Further, adjustments, disabling, or other tuning across the various I/O devices and sensors of the plural standalone digital display devices of the unified digital workspace I/O devices may be conducted to adjust audibility and viewability for the user at the detected user's location within the digital workspace according to embodiments herein. Detection of ambient conditions by any of the unified digital workspace I/O devices may further affect such adjustments, disabling, or tuning changes for optimizations of audibility and viewability for the user at the detected user's location within the digital workspace according to embodiments herein. Flow may then proceed to block 514.

Proceeding to block 514, the information handling system executes the digital display devices audio and visual contextual engine system to activate one or more unified digital workspace I/O devices from across the plural standalone digital display devices, or any active information handling system, in the workspace to detect the location of a user in front of the plural standalone digital display devices. Any combination of I/O sensors may be used to determine the location of the user. For example, plural microphones across any of the standalone digital display devices may be used to detect a user's voice and execution of code instructions for a beamforming algorithm, according to embodiments herein, may be used to identify a direction of a user's voice relative to the plural standalone digital display devices or any active information handling system. In another embodiment, one or more cameras may be used with a facial recognition algorithm to detect a user's face and a direction that a user is facing within the digital workspace. A low-level facial recognition algorithm may be executed on a camera controller, a hardware controller of one of the standalone digital display devices, or a hardware processing resource at the information handling system using a camera feed from the one or more standalone digital display devices in embodiments herein. In yet another embodiment, a range finder, range finder feature of a camera sensor, an infrared sensor, or a proximity sensor may be used to detect a distance or direction of a user within the digital workspace and relative to the plurality of standalone digital display devices and any active information handling system. This user location information, including direction, distance, face orientation relative to one or more of the plural standalone digital display devices, or any active information handling system, may be reported back to the digital display devices audio and visual contextual engine system executing at the information handling system in embodiments herein.

At block 516, and upon determination of a location and orientation of a user within the digital workspace, the digital display devices audio and visual contextual engine system executes to automatically adjust and tune operation of each of the standalone digital display devices, any active information handling system, and their unified digital workspace I/O devices as part of the unified virtual adaptive user interface based on the location of the user relative to the location of the plural digital display devices and any active information handling system in the digital workspace. The digital display devices audio and visual contextual engine system executes to issue adjustment control commands to each standalone digital display device to adjust or disable their unified digital workspace I/O devices as part of the unified virtual adaptive user interface for the user's location in the digital workspace in embodiments herein. The digital display devices audio and visual contextual engine system at the information handling system issues commands to the unified digital workspace I/O devices including display panels, microphones, speakers, cameras, infrared proximity sensors, a range sensors, and other I/O sensor devices to disable I/O sensor devices that may conflict or to adjust settings of those I/O sensor devices for optimizing audibility and viewability for the user at the her detected location and facing orientation within the digital workspace in embodiments herein. Further, the digital display devices audio and visual contextual engine system operating the unified digital workspace I/O devices, including various I/O sensor devices, may also detect the environment, such as ambient sound or whether the user is in a public location context or private location context, to further tune the unified digital workspace I/O devices of the standalone digital display devices for audibility at the user's location in the digital workspace in embodiments herein. Volume of speakers or sensitivity of microphones may be adjusted as well as directionality of microphone recording or projection with speakers may be adjusted for the user's location by the digital display devices audio and visual contextual engine system operating the unified digital workspace I/O devices to tune the unified virtual adaptive user interface for the user in the digital workspace in embodiments herein.

For example as described with respect to FIG. 3, a user's location and facing posture closer to the first standalone digital display device 320 than a second standalone digital display device 380 or any active information handling system 300 may cause the digital display devices audio and visual contextual engine system to automatically tune of the sensitivity and sound beamforming directionality of microphones, such as 329a and 329b, based on the user's detected location. The sensitivity of microphones, such as 329a and 329b in FIG. 3, near the user may be increased and beamforming directionality of the microphones may be directed toward the user location. Additionally, microphones 389a and 389b and a microphone at the information handling system 300 may be disabled or have sensitivity reduced. Similar automatic adjustments to speakers 329a and 329b may be made by the digital display devices audio and visual contextual engine system in terms of volume or even sound directionality while other speakers maybe reduced or disabled in some embodiments or increased for a surround sound effect in other embodiments. Thus, the information handling system executing code instructions of the digital display devices audio and visual contextual engine system establishes the unified virtual adaptive user interface across plural standalone digital display devices and automatically adjusts and tunes the unified super set of digital workspace I/O devices for audibility to the user across the plural standalone digital display devices and any active information handling system in a digital workspace relative to a user's detected location in the digital workspace according to an embodiment of the present disclosure.

At block 518, the information handling system may execute machine readable code instructions of the digital display devices audio and visual contextual engine system to automatically adjust display panels and content displayed thereon for the plural standalone digital display devices and any active integrated display device of an information handling system in the digital workspace for the user's location in an embodiment. For example and with respect to FIG. 3, additional automatic adjustments and tuning to digital display panels 323 and 383 as well as the integrated digital display device 391 if active, may be made for contrast, brightness, sharpness, or color depending on location of the user and any detected lighting conditions at the user's location and vantage point. Similar automatic contextual adjustments may be executed by the digital display devices audio and visual contextual engine system to content displayed on the digital display panels 323 and 383 as well as the integrated digital display device 391 if active, generated from executing software applications relating to location of content among the display panels 323, 383, or 391 as well as magnification size and other aspects of content presented based on the user's detected location, such as distance or angle of gaze, within the digital workspace relative to the plural standalone digital display devices 320 or 380 or any active information handling system according to embodiments herein. Further, the digital display devices audio and visual contextual engine system operating the unified digital workspace I/O devices, including various I/O sensor devices, may also detect the environment, such as ambient lighting or whether the user is in a public location context or private location context, to further tune the unified digital workspace I/O devices such as the display panels, content displayed, or operation of various cameras of the standalone digital display devices for viewability at the user's location in the digital workspace in embodiments herein

In other embodiments, adjustments may be made to cameras 325, 385, and camera, such as I/O device 390 on any active information handling system 300 operating within the unified virtual adaptive user interface across plural standalone digital display devices 320, 380 in the digital workspace 301. Cameras 325, 385 and on any active information handling system 300 may be adjusted for brightness, sharpness, color, and detected ambient light conditions such as for video communication via the unified virtual adaptive user interface across plural standalone digital display devices 320 and 380 or any active information handling system 300. Further, the digital display devices audio and visual contextual engine system may select among the plural cameras 325, 385 or on any active information handling system and disable other depending on user location, such as angle or proximity of a user's face or gaze direction automatically and disable other cameras for video communications in the unified virtual adaptive user interface of the digital workspace in some embodiments. Therefore, the information handling system executing code instructions of the digital display devices audio and visual contextual engine system establishes the unified virtual adaptive user interface across plural standalone digital display devices and automatically adjusts and tunes the various display panels and content displayed thereon of the digital workspace I/O devices for viewability by the user across the plural standalone digital display devices and any active information handling system in a digital workspace relative to a user's detected location in the digital workspace according to embodiments of the present disclosure

At block 520, the information handling system may execute machine readable code instructions of the digital display devices audio and visual contextual engine system to monitor a user's location with the unified digital workspace I/O devices, including with any of a plurality of sensors across the plural standalone digital display devices or any active information handling system, used to determine to user's location described in embodiments above. A periodic or continuous monitoring of the user's location may be conducted by one or more camera systems, microphones, range finders, proximity sensors or any combination to detect when a user's location in the digital workspace has changed. Periodic monitoring of the user's location may be conducted by one or more camera systems, microphones, range finders, proximity sensors or any combination with relative frequency such as once every minute or every several seconds in some embodiments while a user's presence is detected. The digital display devices audio and visual contextual engine system may determine movement distance by a user's head within the mapped digital workspace and plural standalone digital display devices relative to a movement distance threshold. An example movement distance threshold may be 10 cm although any movement distance threshold may be used depending on desired sensitivity. The determined movement distance threshold is used to eliminate smaller shifts or smaller movements by the user's head during operation with unified virtual adaptive user interface in the digital workspace.

In another embodiment, a timer may be used at the digital display devices audio and visual contextual engine system. When movement of the user is detected by any of the one or more unified digital workspace I/O devices or sensors that reaches a sufficient user movement threshold, a timer is started to determine whether the movement, such as of a user's head or face, is a temporary movement relative to a movement timing threshold. A movement timing threshold may be for 15 seconds, 30 seconds, a minute or any other timing period duration in various embodiments and may be set based on a desired sensitivity for automatic adjustments to the unified virtual adaptive user interface.

If at block 520, the user's position in the digital workspace has changed by more than a movement distance threshold in a digital workspace relative to the standalone digital display devices and for more than a threshold movement timing period, flow may return to block 514. At block 514, the digital display devices audio and visual contextual engine system executes to re-assess the user's location relative to the standalone digital display devices and any active information handling system in the digital workspace. Then, in an embodiment, the digital display devices audio and visual contextual engine system may execute to re-adjust audio and visual I/O devices of the plural standalone digital display devices or any active information handling system to optimize audibility and viewability of the user at the new location in the digital workspace. If at block 520, the user's position in the digital workspace has not changed by more than a threshold distance threshold in the digital workspace relative to the standalone digital display devices to account for allowance for smaller movements or the movement has not lasted for more than a movement timing threshold period to allow for temporary movements, flow may proceed to block 522.

At block 522, the digital display devices audio and visual contextual engine system executing on the information handling system monitors for changes in the standalone digital display devices that are detected as operatively coupled within the digital workspace for the unified virtual adaptive user interface. For example, if a new standalone digital display device is detected as added or an existing digital display device is removed or wirelessly de-coupled, physically moved as to location, or recoupled, this may comprise a change in the standalone digital display devices detected as operatively coupled within the digital workspace at block 522. Similarly, opening or closing a display lid of the information handling system or changing orientation of a tablet display from active viewing orientation to an inactive orientation or vice-versa may comprise a change in display devices within the digital workspace. Further, the digital display devices audio and visual contextual engine system executing on the information handling system may periodically use the digital displays location detection systems at one or more standalone digital display devices to monitor and confirm locations of the plural standalone digital display devices within the digital workspace. For example, monitoring of location, such as with an inaudible tone or beep, may occur one per day, such as in the morning upon boot up, or plural times per day upon waking of the information handling system or at other periodic times. If at block 522, a change in the display devices within the unified virtual adaptive user interface for the workspace is detected, then flow may return to block 502 to detect operatively coupled standalone digital display devices for establishing the locations in the digital workspace and the method may proceed as described. If no change in display devices is detected at block 522, flow proceeds to block 524.

At block 524, the information handling system executing the digital display devices audio and visual contextual engine system detects if the information handling system or the plural standalone digital display devices are powered down. If the information handling system or the plural standalone digital display devices of the digital workspace do not power down at block 524, then the flow proceeds to block 520 with the digital display devices audio and visual contextual engine system monitoring for user movement as described. If the information handling system or the plural standalone digital display devices of the digital workspace do power down at block 524, then the method may end.

The blocks of the flow diagram of FIG. 5 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those capable in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system operating a unified virtual adaptive user interface across plural standalone digital display devices in a digital workspace comprising:
a hardware processor, memory, and a power management system for providing power to the hardware processor and memory;
a network interface device to detect operatively coupling of a first standalone digital display device and a second standalone digital display device to form a digital workspace and to automatically receive location data of the first standalone digital display device relative to the second standalone digital display device in the digital workspace determined from microphone beamforming location identification using a tone detected by a first microphone on the first standalone digital display device from a second speaker of the second standalone digital display device;
the hardware processor executing machine readable code instructions of a digital display devices audio and visual contextual engine system to unify operation of digital workspace I/O devices including the first microphone and a first speaker at the first standalone digital display device and a second microphone and the second speaker at the second standalone digital display device to operate as the unified virtual adaptive user interface for the digital workspace;
the hardware processor to utilize the unified digital workspace I/O devices to detect a user location in the digital workspace relative to the first standalone digital display device and the second standalone digital display device; and
the hardware processor executing machine readable code instructions of a digital display devices audio and visual contextual engine system to automatically adjust and tune operation of the first standalone digital display device, the second standalone digital display device, and the digital workspace I/O devices as part of the unified virtual adaptive user interface based on the location of the user, locations and orientations of the first standalone digital display device and the second standalone digital display device in the digital workspace.

2. The information handling system of claim 1, wherein the network interface device operatively receives location data of the first standalone digital display device relative to the second standalone digital display device in the digital workspace determined from the microphone beamforming location identification using a second tone detected by the second microphone on the second standalone digital display device from the first speaker of the first standalone digital display device.

3. The information handling system of claim 1, wherein the network interface device receives location data of the first standalone digital display device relative to the second standalone digital display device in the digital workspace determined from a first side-mounted proximity sensor on the first standalone digital display device in the digital workspace.

4. The information handling system of claim 1 further comprising:
a first camera sensor at the first standalone digital display device included with the unified operation of the digital workspace I/O devices as part of the unified virtual adaptive user interface in the digital workspace; and
the first camera sensor to detect the user location in the digital workspace relative to the first standalone digital display device and the second standalone digital display device via images and with the microphone beamforming location identification for the user from the first microphone and the second microphone detecting a sound from the user.

5. The information handling system of claim 1 further comprising:
a first camera sensor at the first standalone digital display device and a second camera sensor at the second standalone digital display device included with the unified operation of the digital workspace I/O devices as part of the unified virtual adaptive user interface in the digital workspace; and
the first camera sensor and the second camera sensor to detect the user location in the digital workspace relative to the first standalone digital display device and the second standalone digital display device.

6. The information handling system of claim 1 further comprising:
the hardware processor executing machine readable code instructions of a digital display devices audio and visual contextual engine system to determine if a laptop lid with an integrated display device is open to include the integrated display device; and
the integrated display device, and a third microphone, and a third speaker of the information handling system included with the unified operation of the digital workspace I/O devices as part of the unified virtual adaptive user interface in the digital workspace.

7. The information handling system of claim 1 further comprising:
the hardware processor executing machine readable code instructions of the digital display devices audio and visual contextual engine system to automatically adjust volume of the first speaker and the second speaker and adjust microphone sensitivity of or disable the first microphone and the second microphone based on closeness of the detected user location to the first standalone digital display device and the second standalone digital display device respectively in the digital workspace.

8. The information handling system of claim 1 further comprising:
the hardware processor executing machine readable code instructions of the digital display devices audio and visual contextual engine system to automatically adjust display brightness, contrast and content magnification of the first standalone digital display device and the second standalone digital display device based on closeness of the detected user location to the first standalone digital display device and the second standalone digital display device respectively in the digital workspace.

9. An information handling system operating a unified virtual adaptive user interface across plural standalone digital display devices in a digital workspace comprising:
a hardware processor, memory, and a power management system for providing power to the hardware processor and memory;
a network interface device to detect operatively coupling of a first standalone digital display device and a second standalone digital display device to form a digital workspace and to automatically receive location data of the first standalone digital display device relative to the second standalone digital display device in the digital workspace determined from microphone beamforming location identification using a tone detected by a first microphone on the first standalone digital display device from a second speaker of the second standalone digital display device;
the hardware processor executing machine readable code instructions of a digital display devices audio and visual contextual engine system to unify operation of digital workspace I/O devices including the first microphone and a first speaker at the first standalone digital display device and a second microphone and the second speaker at the second standalone digital display device to operate as the unified virtual adaptive user interface for the digital workspace;
the hardware processor executing machine readable code instructions of a digital display devices audio and visual contextual engine system to detect when a laptop lid is open and to include an integrated display device, a third microphone, and a third speaker of the information handling system with the unified operation of the digital workspace I/O devices as part of the unified virtual adaptive user interface in the digital workspace when the laptop lid is open;
the hardware processor to utilize the unified digital workspace I/O devices to detect a user location in the digital workspace relative to the first standalone digital display device and the second standalone digital display device; and
the hardware processor executing machine readable code instructions of a digital display devices audio and visual contextual engine system to automatically adjust and tune operation of the first standalone digital display device, the second standalone digital display device, and the digital workspace I/O devices as part of the unified virtual adaptive user interface based on the location of the user, the first standalone digital display device, and the second standalone digital display device in the digital workspace.

10. The information handling system of claim 9, wherein the hardware processor executes machine readable code instructions of the digital display devices audio and visual contextual engine system to detect when the laptop lid with the integrated display device is closed and turn off the integrated display device and a camera at the information handling system from the digital workspace I/O devices as part of the unified virtual adaptive user interface in the digital workspace.

11. The information handling system of claim 9 further comprising:
a camera selected from a first camera sensor at the first standalone digital display device, a second camera sensor at the second standalone digital display device, and a third camera sensor at the information handling system on the laptop lid included with the unified operation of the digital workspace I/O devices as part of the unified virtual adaptive user interface in the digital workspace; and
the camera to detect the user location in the digital workspace relative to the first standalone digital display device, the second standalone digital display device, and the information handling system via images and with the microphone beamforming location identification for the user location from a plurality of microphones selected from the first microphone, the second microphone, and the third microphone detecting a sound from the user.

12. The information handling system of claim 9 further comprising:
a first camera sensor at the first standalone digital display device, a second camera sensor at the second standalone digital display device, and a third camera at the information handling system on the laptop lid included with the unified operation of the digital workspace I/O devices as part of the unified virtual adaptive user interface in the digital workspace; and
at least two of the first camera sensor, the second camera sensor, or the third camera sensor to detect the user location in the digital workspace relative to the first standalone digital display device, the second standalone digital display device, and the information handling system.

13. The information handling system of claim 9 further comprising:
the hardware processor executing machine readable code instructions of the digital display devices audio and visual contextual engine system to automatically adjust volume of the first speaker and the second speaker and adjust microphone sensitivity of or disable the first microphone and the second microphone based on the detected user location and proximity to a detected ambient noise in the digital workspace.

14. The information handling system of claim 9 further comprising:
the hardware processor executing machine readable code instructions of the digital display devices audio and visual contextual engine system to automatically adjust display brightness, contrast and content magnification of the first standalone digital display device and the second standalone digital display device based on closeness of the detected user location to the first standalone digital display device and the second standalone digital display device respectively in the digital workspace.

15. An information handling system operating a unified virtual adaptive user interface across plural standalone digital display devices in a digital workspace comprising:
a hardware processor, memory, and a power management system for providing power to the hardware processor and memory;
a network interface device to detect operatively coupling of a first standalone digital display device and a second standalone digital display device to form a digital workspace and to automatically receive location data of the first standalone digital display device relative to the second standalone digital display device in the digital workspace determined from detected exchange of sound waves or proximity device waves between the first standalone digital display device and the second standalone digital display device in the digital workspace;
the hardware processor executing machine readable code instructions of a digital display devices audio and visual contextual engine system to unify operation of digital workspace I/O devices including a first display panel, a first microphone, and a first speaker at the first standalone digital display device and a second display panel, a second microphone, and a second speaker at the second standalone digital display device to operate as the unified virtual adaptive user interface for the digital workspace;
the hardware processor executing machine readable code instructions of a digital display devices audio and visual contextual engine system to detect when a laptop lid is open and to include an integrated display device, a third microphone, and a third speaker of the information handling system with the unified operation of the digital workspace I/O devices as part of the unified virtual adaptive user interface when the laptop lid is open;
the hardware processor to utilize the unified digital workspace I/O devices to detect a user location in the digital workspace relative to the first standalone digital display device and the second standalone digital display device; and
the hardware processor executing machine readable code instructions of a digital display devices audio and visual contextual engine system to automatically adjust and tune operation of the first standalone digital display device, the second standalone digital display device, and the digital workspace I/O devices as part of the unified virtual adaptive user interface based on the location of the user, the first standalone digital display device, and the second standalone digital display device in the digital workspace.

16. The information handling system of claim 15, wherein the hardware processor executes machine readable code instructions of the digital display devices audio and visual contextual engine system to turn off the third microphone and the third speaker of the information handling system from the digital workspace I/O devices when the laptop lid is detected as closed.

17. The information handling system of claim 15, wherein the location data of the first standalone digital display device relative to the second standalone digital display device in the digital workspace is determined from detected exchange of proximity sensor waves determined from a first side-mounted proximity sensor on the first standalone digital display device and a second side-mounted proximity sensor on the second standalone digital display device in the digital workspace.

18. The information handling system of claim 15, wherein the location data of the first standalone digital display device relative to the second standalone digital display device in the digital workspace is determined from detected exchange of sound waves by microphone beamforming location identification using a tone detected by the first microphone on the first standalone digital display device from the second speaker of the second standalone digital display device.

19. The information handling system of claim 15 further comprising:
the hardware processor executing machine readable code instructions of the digital display devices audio and visual contextual engine system to automatically adjust volume of the first speaker, the second speaker, and the third speaker and adjust microphone sensitivity of or disable the first microphone, the second microphone and the third microphone based on closeness of the detected user location to the first standalone digital display device, the second standalone digital display device, and the information handling system respectively in the digital workspace.

20. The information handling system of claim 15 further comprising:
the hardware processor executing machine readable code instructions of the digital display devices audio and visual contextual engine system to automatically adjust display brightness, contrast and content magnification of the first standalone digital display device and the second standalone digital display device based on closeness of the detected user location to the first standalone digital display device and the second standalone digital display device respectively in the digital workspace.
